(19) United States
(12) Patent Application Publication
(10) Pub. No.: US 2026/0009923 A1
(43) Pub. Date: Jan. 8, 2026

(54) SADDLE COILS WITH DEEP QUADRANT SENSITIVITY FOR CIRCUMFERENTIAL IMAGING OF CASINGS

(71) Applicant: Schlumberger Technology Corporation, Sugar Land, TX (US)

(72) Inventor: Saad Omar, Cambridge, MA (US)

(21) Appl. No.: 18/763,944

(22) Filed: Jul. 3, 2024

(51) Int. Cl. G01V 3/28; G01V 3/38

(52) U.S. Cl. CPC G01V 3/28; G01V 3/38

(57) ABSTRACT

Techniques and apparatus for determining quadrant-based locations of casing defects based on multi-frequency, non-collocated, induction measurements are described. An electromagnetic (EM) inspection tool is operated inside of a well including multiple casings. The EM inspection tool includes a triaxial transmitter and multiple triaxial receivers, each being located at a different spacing from the triaxial transmitter. The triaxial transmitter is configured to emit primary time-varying magnetic field signals in a radial direction, a tangential direction, and an axial direction. Each respective primary time-varying magnetic field signal induces corresponding secondary time-varying magnetic field signal(s) in the radial direction, the tangential direction, and the axial direction that are detected by one or more of the triaxial receivers. Induction measurements of the casings are obtained using the EM inspection tool, and a quadrant of a casing in which a defect of the casing is located is determined based on the induction measurements.

### BACKGROUND

### Field of the Disclosure

The present disclosure relates to evaluating multi-casing wells using induction measurements. More specifically, the present disclosure provides techniques and apparatus for determining quadrant-based locations of casing defects based on multi-frequency, non-collocated, induction measurements obtained via one or more triaxial transmitter-receiver pairs of an electromagnetic inspection tool.

### Description of Related Art

Well integrity evaluations, such as well casing integrity evaluations, provide vital information for natural resources (e.g., oil, gas, or water) production and various aspects (e.g., safety, environment, or cost) related to the production. Well casing integrity may be referred to as maintaining full control of well casings (e.g., pipes or tubes) within a well at all times, in order to prevent unintended fluid movement or loss of containment to the environment in drilling and well operations. Well casing defects may cause casing strength degradation, casing deformation, well suspension, and even well abandonment. However, complexities inside and surrounding the well in different environments may create challenges for accurately mapping various casing defects (e.g., casing thickness variations due to wear or corrosion) in a vicinity of the well.

A well integrity evaluation may involve performing well logging or inspection via electromagnetic (EM) field testing. In EM field testing, a field-testing probe is slid within an interior diameter of a conductive casing or tubular. A transmitter of the field-testing probe induces an EM field that interacts with the casing. The EM field may vary depending on thickness and/or corrosion in the casing. Receivers may detect these variations in the EM field. Based on these detected variations, the effective thickness and/or corrosion of the casing may be determined.

### SUMMARY

One embodiment of the present disclosure described herein is a method. The method generally includes operating an electromagnetic (EM) inspection tool inside of a well including a plurality of casings. The EM inspection tool includes a triaxial transmitter and a plurality of triaxial receivers configured to operate at one or more frequencies. Each of the plurality of triaxial receivers is located at a different spacing with respect to the triaxial transmitter. The triaxial transmitter is configured to emit a respective one or more primary time-varying magnetic field signals in the plurality of casings in a radial direction, a tangential direction, and an axial direction with respect to the plurality of casings, each of the respective one or more primary time-varying magnetic field signals induces a corresponding one or more secondary time-varying magnetic field signals in the plurality of casings in the radial direction, the tangential direction, and the axial direction, and the one or more secondary time-varying magnetic field signals are detected by one or more of the plurality of triaxial receivers. The method also includes obtaining, using the EM inspection tool, induction measurements of the plurality of casings. The method further includes determining, for at least one casing of the plurality of casings, a quadrant of the least one casing in which at least one defect of the at least one casing is located, based on the induction measurements.

Another embodiment of the present disclosure described herein is a system. The system includes a plurality of casings disposed in a well, an electromagnetic (EM) inspection tool disposed in the plurality of casings, and a control system communicatively coupled to the EM inspection tool. The EM inspection tool includes a triaxial transmitter and a plurality of triaxial receivers configured to operate at one or more frequencies. Each of the plurality of triaxial receivers is located at a different spacing with respect to the triaxial transmitter. The triaxial transmitter is configured to emit a respective one or more primary time-varying magnetic field signals in the plurality of casings in a radial direction, a tangential direction, and an axial direction with respect to the plurality of casings, each of the respective one or more primary time-varying magnetic field signals induces a corresponding one or more secondary time-varying magnetic field signals in the plurality of casings in the radial direction, the tangential direction, and the axial direction, and the one or more secondary time-varying magnetic field signals are detected by one or more of the plurality of triaxial receivers. The control system includes one or more memories collectively storing instructions and one or more processors coupled to the one or more memories. The one or more processors are collectively configured to execute the instructions to cause the control system to perform an operation. The operation includes obtaining, using the EM inspection tool, induction measurements of the plurality of casings. The operation also includes determining, for at least one casing of the plurality of casings, a quadrant of the at least one casing in which at least one defect of the at least one casing is located, based on the induction measurements.

Another embodiment of the present disclosure described herein is a non-transitory computer-readable medium. The non-transitory computer-readable medium includes computer-executable instructions that, when executed by one or more processors of a computing system, cause the computing system to perform an operation. The operation includes operating an electromagnetic (EM) inspection tool inside of a well comprising a plurality of casings. The EM inspection tool includes a triaxial transmitter and a plurality of triaxial receivers configured to operate at one or more frequencies, each of the plurality of triaxial receivers being located at a different spacing with respect to the triaxial transmitter. The triaxial transmitter is configured to emit a respective one or more primary time-varying magnetic field signals in the plurality of casings in a radial direction, a tangential direction, and an axial direction with respect to the plurality of casings, each of the respective one or more primary time-varying magnetic field signals induces a corresponding one or more secondary time-varying magnetic field signals in the plurality of casings in the radial direction, the tangential direction, and the axial direction, and the one or more secondary time-varying magnetic field signals are detected by one or more of the plurality of triaxial receivers. The operation also includes obtaining, using the EM inspection tool, induction measurements of the plurality of casings. The operation further includes determining, for at least one casing of the plurality of casings, a quadrant of the least one casing in which at least one defect of the at least one casing is located, based on the induction measurements.

The following description and the appended figures set forth certain features for purposes of illustration.

### BRIEF DESCRIPTION OF DRAWINGS

Various embodiments in accordance with the present disclosure will be described with reference to the drawings, where like designations denote like elements. Note that the appended drawings illustrate typical embodiments and are therefore not to be considered limiting; other equally effective embodiments are contemplated.

FIG. 1 depicts a schematic diagram of at least a portion of an example system, according to various embodiments.

FIG. 2 depicts a schematic diagram of at least a portion of an example implementation of an EM inspection tool, according to various embodiments.

FIG. 3 depicts a schematic diagram of an example implementation of the EM inspection tool shown in FIG. 2, according to various embodiments.

FIG. 4 depicts an example triaxial transmitter, according to various embodiments.

FIG. 5 depicts an example triaxial receiver, according to various embodiments.

FIG. 6A depicts an example X-directed saddle coil, according to various embodiments.

FIG. 6B depicts an example Y-directed saddle coil, according to various embodiments.

FIG. 7 depicts a schematic diagram of at least a portion of an EM inspection tool deployed within at least a portion of a multi-casing well, according to various embodiments.

FIG. 8 depicts an example of different geometrical quadrants of a casing, according to various embodiments.

FIG. 9 depicts an example of a multi-casing evaluation system, according to various embodiments.

FIG. 10 depicts real and imaginary components of cross couplings for a triaxial transmitter-receiver pair within a two-casing configuration, according to various embodiments.

FIG. 11 depicts real and imaginary components of cross couplings for another triaxial transmitter-receiver pair within a two-casing configuration, according to various embodiments.

FIG. 12 depicts real and imaginary components of cross couplings for a triaxial transmitter-receiver pair within a three-casing configuration, according to various embodiments.

FIG. 13 depicts real and imaginary components of cross couplings for another triaxial transmitter-receiver pair within a three-casing configuration, according to various embodiments.

FIG. 14 depicts real and imaginary components of cross couplings for another triaxial transmitter-receiver pair within a three-casing configuration, according to various embodiments.

FIG. 15 depicts real and imaginary components of cross couplings for a triaxial transmitter-receiver pair within a four-casing configuration, according to various embodiments.

FIG. 16 depicts real and imaginary components of cross couplings for another triaxial transmitter-receiver pair within a four-casing configuration, according to various embodiments.

FIG. 17 depicts real and imaginary components of cross couplings for another triaxial transmitter-receiver pair within a four-casing configuration, according to various embodiments.

FIG. 18 depicts out-of-phase real and imaginary components of cross couplings for a triaxial transmitter-receiver pair within a four-casing configuration, according to various embodiments.

FIG. 19 depicts another example of out-of-phase real and imaginary components of cross couplings for a triaxial transmitter-receiver pair within a four-casing configuration, according to various embodiments.

FIG. 20 is a flow diagram depicting example operations for determining quadrant-based locations of casings defects based on multi-frequency, non-collocated, induction measurements.

### DETAILED DESCRIPTION

One challenge associated with conventional electromagnetic (EM) field testing is that, in some cases, localized defects (e.g., corrosion) within one or more casings may be missed with conventional EM inspection tools. For example, in conventional EM inspection tools (e.g., EM corrosion inspection tools), the sensors (e.g., transmitter(s) and receiver(s)) generally use axial coils, which are primarily sensitive to circumferentially induced currents in the metallic casings. Consequently, the sensor response is sensitive to metal loss or volume of metal averaged over the casing circumference proportional to coil length and casing diameter.

However, certain natural defects, such as corrosion, may not respect any symmetry within the casing and generally start occurring in a localized casing region. Such a localization of metal loss can be missed by axial coils due to their circumferentially averaged sensitivity. These metal losses may lead to holes and leakages that compromise the well's integrity. Accordingly, there exists a need for further improvements in EM inspection tools and EM field testing.

The disclosure provides techniques, methods, systems, apparatus, and computer readable media for determining quadrant-based locations of casing defects based on multi-frequency, non-collocated, induction measurements obtained via one or more triaxial transmitter-receiver pairs of an EM inspection tool. For example, the disclosure provides techniques for identifying and localizing, in a geometrical quadrant (e.g., a given sector of 90 degrees), the presence of a defect (e.g., metal loss or gain) in each casing of a nested multi-casing configuration (e.g., up to four casings), based on the multi-frequency, non-collocated, induction measurements.

In certain embodiments, the EM inspection tool includes a triaxial transmitter and one or more triaxial receivers configured to operate at one or more frequencies. Each triaxial receiver may be positioned at a respective axial distance (or spacing) (e.g., denoted as “d,” where a value of “d” is equal to zero representing a collocated triaxial receiver or is greater than zero representing a non-collocated triaxial receiver) from the triaxial transmitter. Note, each respective combination of the triaxial transmitter with a different triaxial receiver may be referred to herein as a respective “triaxial transmitter-receiver pair.”

The triaxial transmitter (Tx) includes: (i) a coil directed (or aligned) in an X direction (or radial direction) with respect to the EM inspection tool and configured to generate an EM field(s) in the X direction (referred to herein as an “X Tx coil”); (ii) a coil directed (or aligned) in a Y direction (or tangential direction) with respect to the EM inspection tool and configured to generate an EM field(s) in the Y direction (referred to herein as a “Y Tx coil”); and (iii) a coil directed (or aligned) in a Z direction (or axial direction) with respect to the EM inspection tool and configured to generate an EM field(s) in the Z direction (referred to herein as a “Z Tx coil” or “Tx axial coil”). In certain embodiments, the X Tx coil is implemented with an X-directed saddle coil and the Y Tx coil is implemented with a Y-directed saddle coil.

Similarly, each triaxial receiver (Rx) includes (i) a coil directed (or aligned) in an X direction (or radial direction) with respect to the EM inspection tool and configured to detect and measure EM field(s) in the X direction (referred to herein as an “X Rx coil”); (ii) a coil directed (or aligned) in a Y direction (or tangential direction) with respect to the EM inspection tool and configured to detect and measure EM field(s) in the Y direction (referred to herein as a “Y Rx coil”); and (iii) a coil directed (or aligned) in a Z direction (or axial direction) with respect to the EM inspection tool and configured to detect and measure EM field(s) in the Z direction (referred to herein as a “Z Rx coil” or “Rx axial coil”). In certain embodiments, the X Rx coil is implemented with an X-directed saddle coil and the Y Rx coil is implemented with a Y-directed saddle coil.

In certain embodiments, the EM inspection tool is inserted into a well including multiple casings (also referred to herein as tubulars or pipes). For example, the EM inspection tool may be inserted into an interior diameter of an inner casing (or other conductive tubular) of the casings. The EM inspection tool is controlled to measure and generate data including multi-frequency, non-collocated (e.g., multiple spacing), induction measurements for the casings. For example, the triaxial transmitter of the EM inspection tool may be excited by a time-domain pulse and a series of continuous wave (CW) multi-frequency excitations. For each excitation frequency, each of the X Tx coil current, the Y Tx coil current, and the Z Tx coil current may generate a respective primary EM field (including one or more primary time-varying magnetic field signals) that is distributed in space within the casings in a respective X (radial) direction, Y (tangential) direction, and Z (axial) direction.

The primary EM fields from the X Tx coil, Y Tx coil, and Z Tx coil induce eddy currents in the casings, and the eddy currents produce a corresponding one or more returning (secondary) EM fields (including one or more secondary time-varying magnetic field signals) that are distributed in space within the casings. The triaxial receiver(s) of the EM inspection tool may detect and measure the primary EM fields generated by the triaxial transmitter, the returning (secondary) EM fields, or a combination thereof, to generate data including multi-frequency, non-collocated (e.g., multiple spacing), induction measurements. For example, in certain embodiments, the EM inspection tool includes multiple triaxial receivers positioned at various axial distances (or spacings) from the triaxial transmitter such that the multiple triaxial receivers measure the primary EM fields generated by the triaxial transmitter, the returning (secondary) EM fields, or a combination thereof, and generate the multi-frequency, non-collocated (e.g., multiple spacing), induction measurements.

For each triaxial receiver, the X Rx coil of the triaxial receiver may perform sensing in the X direction, the Y Rx coil of the triaxial receiver may perform sensing in the Y direction, and the Z Rx coil of the triaxial receiver may perform sensing in the Z direction. Thus, in certain embodiments, for each triaxial transmitter-receiver pair, the induction measurements include a respective set of magnitude and/or phase measurements associated with each cross coupling combination of the triaxial transmitter coils with the triaxial receiver coils. For example, for each triaxial transmitter-receiver pair, the induction measurements may include respective magnitude and/or phase measurements from (i) a cross coupling of the X Tx coil with the X Rx coil (referred to herein as an “XX cross coupling”), (ii) a cross coupling of the X Tx coil with the Y Rx coil (referred to herein as an “XY cross coupling”), (iii) a cross coupling of the X Tx coil with the Z Rx coil (referred to herein as an “XZ cross coupling”), (iv) a cross coupling of the Y Tx coil with the X Rx coil (referred to herein as an “YX cross coupling”), (v) a cross coupling of the Y Tx coil with the Y Rx coil (referred to herein as an “YY cross coupling”), (vi) a cross coupling of the Y Tx coil with the Z Rx coil (referred to herein as an “YZ cross coupling”), (vii) a cross coupling of the Z Tx coil with the X Rx coil (referred to herein as an “ZX cross coupling”), (viii) a cross coupling of the Z Tx coil with the Y Rx coil (referred to herein as an “ZY cross coupling”), (ix) a cross coupling of the Z Tx coil with the Z Rx coil (referred to herein as an “ZZ cross coupling”), or (x) any combination thereof.

As described in greater detail below, in certain embodiments, the multi-frequency, non-collocated, induction measurements obtained via the EM inspection tool provide quadrant sensitivity to locations of one or more defects within one or more casings of a well. For example, the quadrant-based location of at least one defect (e.g. metal loss or gain) within one or more casings (e.g., up to four casings) can be determined based on analyzing the multi-frequency, non-collocated, induction measurements. As used herein, a quadrant may refer to a given sector of 90 degrees (°) of the casing at a position along the longitudinal axis of the casing. For example, each casing (e.g., cylindrical tubular) may include, at a given position along the longitudinal axis of the casing, four quadrants: a (northeast) quadrant from 0° to 90°, a (northwest) quadrant from 90° to 180°, a (southwest) quadrant from 180° to 270°, and a (southeast) quadrant from 270° to 360°.

In certain embodiments, the underlying quadrant sensitivity of at least one of (i) the cross coupling of the X Tx coil with the Y Rx coil (e.g., XY cross coupling) or (ii) the cross coupling of the Y Tx coil with the X Rx coil (e.g., YX cross coupling) at shorter spacings (e.g., approximately 5-10 inches from the triaxial transmitter) is used to identify and localize, within a geometrical quadrant, the presence of defect(s) within the innermost “first” casing and adjacent “second” outer casing. Additionally or alternatively, in certain embodiments, the underlying lateral sensitivity of at least one of (i) the cross coupling of the X Tx coil with the Z Rx coil (e.g., XZ cross coupling) or (ii) the cross coupling of the Y Tx coil with the Z Rx coil (e.g., YZ cross coupling) combined with sign-based quadrant assignment from at least one of (i) the out-of-phase cross coupling of the X Tx coil with the Z Rx coil or (ii) the out-of-phase cross coupling of the Y Tx coil with the Z Rx coil is used to identify and localize, within a geometrical quadrant, the presence of defect(s) within the “third” and “fourth” outer casings of a multi-casing well.

The techniques, methods, systems, apparatus, and computer readable media for determining quadrant-based locations of casing defects based on multi-frequency, non-collocated, induction measurements obtained via one or more triaxial transmitter-receiver pairs of an EM inspection tool may provide various advantages. For example, the quadrant and deep (e.g., longer spacing) lateral sensitivities from the multi-frequency, non-collocated, induction measurements can be analyzed to provide a directional detection of localized corrosion spots on the inner or outer surface of the casing compared to existing axial coil-based sensors. As such, performing EM field testing using an EM inspection tool with circumferentially sensitive sensors (e.g., one or more triaxial transmitter-receiver pairs) as described herein may allow for early detection and quadrant-based localization of one or more defects, ensuring well integrity.

The following description includes embodiments of the best mode presently contemplated for practicing the described implementations. This description is not to be taken in a limiting sense, but rather is made merely for the purpose of describing the general principles of the implementations. The scope of the described implementations should be ascertained with reference to the issued claims.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

### Example System for Evaluating a Multi-Casing Well

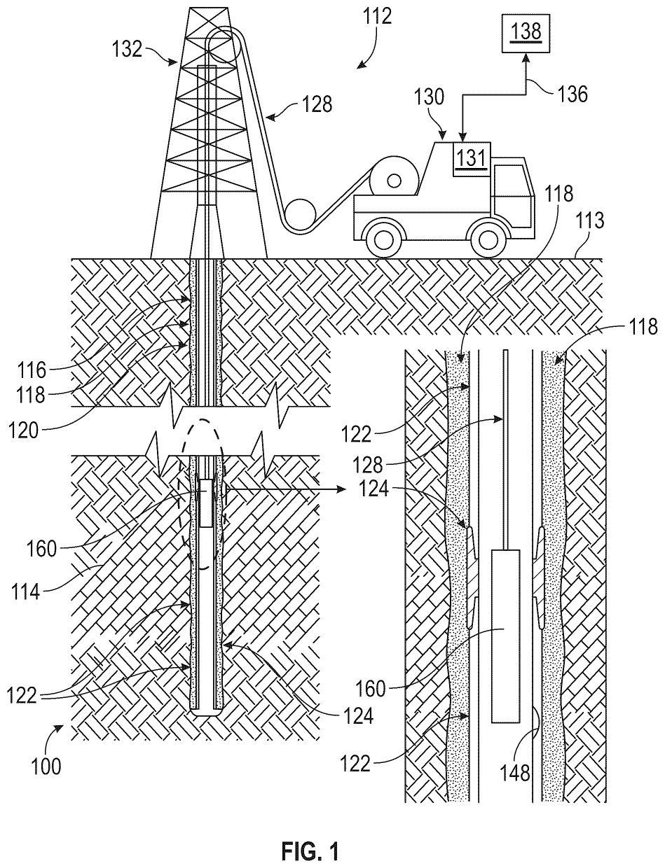

FIG. 1 is a schematic diagram of at least a portion of an example implementation of a system 100 for evaluating a multi-casing well using a downhole EM inspection tool 160, according to various embodiments. As shown, surface equipment 112 is located on a wellsite surface 113 above a geological formation 114 into which a wellbore 116 extends from the wellsite surface 113. An annular fill 118 has been used to seal an annulus 120 between the wellbore 116 and casings (e.g., tubulars) 122, such as via cementing operations. The EM inspection tool 160 may be centered or decentered (e.g., eccentered), such that a measuring and/or detecting device (e.g., a triaxial transmitter or a triaxial receiver) of the EM inspection tool 160 is positioned centrally or off-center relative to a central longitudinal axis of the casings 122.

The casings 122 may be coupled together by collars 124. The casings 122 represent lengths of pipe including threads and/or other means for connecting each end to threads and/or other connection means of an adjacent collar 124 and/or casing 122. Each casing 122 and/or collar 124 may be made of steel and/or other electrically conductive materials able to withstand a variety of forces, such as collapse, burst, and tensile failure, as well as chemically-aggressive fluid. Each casing 122 and/or collar 124 may have magnetic properties and be affected by an alternating EM current.

The surface equipment 112 may carry out various well-inspection (or well-logging) operations to detect conditions (e.g., thicknesses) of the casings 122, including implementations in which the casings 122 are concentrically nested, as shown in FIG. 3, for example. The well-inspection operations may measure individual and/or cumulative thicknesses of the casings 122 by using the EM inspection tool 160.

The EM inspection tool 160 may be conveyed within the wellbore 116 by a cable 128. Such cable 128 may include one or more mechanical cables, electrical cables, and/or electro-optical cables that include one or more fiber-optic lines protected against the harsh environment of the wellbore 116. In certain embodiments, the EM inspection tool 160 is conveyed using other conveyance means, such as coiled tubing or a tractor.

The EM inspection tool 160 may generate time-varying magnetic field signals that interact with the casings 122. The EM inspection tool 160 may be energized from the surface (e.g., via the cable 128) or have its own internal power used to emit the time-varying magnetic field signals via one or more EM sources (e.g., triaxial transmitters). The time-varying magnetic field signals may travel outward from the EM inspection tool 160 in different directions with respect to a center longitudinal axis of the casings 122, including, for example, an X (radial) direction, a Y (tangential) direction, and a Z (axial) direction. Each time-varying magnetic field signal emitted in the different directions may generate eddy currents in the casings 122, which produce corresponding returning magnetic field signals in the different directions (e.g., X (radial) direction, Y (tangential) direction, and Z (axial) direction) that are measured as magnetic field anomalies by one or more triaxial receivers (e.g., sensors) in the EM inspection tool 160.

At a defect 148 in the casings 122, such as a defect caused by metal gain or loss in the casings 122, the returning magnetic field signals in one or more of the directions may arrive at the EM inspection tool 160 with a change in phase and/or signal strength (e.g., amplitude) induced by the defect 148, relative to other returning magnetic field signals not interacting with (e.g., passing through) the defect 148. As described in greater detail herein, in some cases, combined measurements (e.g., at remote field with remote field eddy current (RFEC), near field, or transition zone) of multiple triaxial receivers may be used to create a data log and to identify and localize, within a geometrical quadrant, the presence of defects 148 (e.g., metal loss or gain) in one or more casings 122 (e.g., up to 4 casings) of the wellbore 116 using EM and/or other suitable field-testing analyses.

The EM inspection tool 160 may be deployed inside the wellbore 116 by the surface equipment 112, which may include a vehicle 130 and a deploying system such as a drilling rig, workover rig, platform, derrick, and/or other surface structure 132. Data (e.g., inspection data) related to the casings 122 gathered by the EM inspection tool 160 may be transmitted to the surface and/or stored in the EM inspection tool 160 (and/or one or more storage systems) for later processing and analysis. The vehicle 130 may be fitted with and/or communicate with a data processing system 138 via a communication component 131 to perform data collection and analysis. When the EM inspection tool 160 provides measurements to the surface equipment 112 (e.g., through the cable 128), the surface equipment 112 may pass the measurements as EM inspection evaluation data 136 to a data processing system 138.

The data processing system 138 may obtain the measurements from the EM inspection tool 160 as raw data. In certain embodiments, the measurements are processed or pre-processed by the EM inspection tool 160 before being sent to the data processing system 138. Processing of the measurements may incorporate using and/or obtaining other measurements, such as from ultrasonic, caliper, and/or other EM logging techniques to better constrain unknown parameters of the casings. Accordingly, the data processing system 138 and/or the EM inspection tool 160 may be utilized in acquiring additional information about the casings 122 and/or the wellbore 116, such as a number of casings 122, nominal thickness of each casing 122, centering of the casings 122 relative to the wellbore 116, centering of the EM inspection tool 160 within the wellbore 116, electromagnetic and/or ultrasonic properties of the casings 122, ambient and/or wellbore temperature, caliper measurements, and/or other parameters (or properties) of the casings 122.

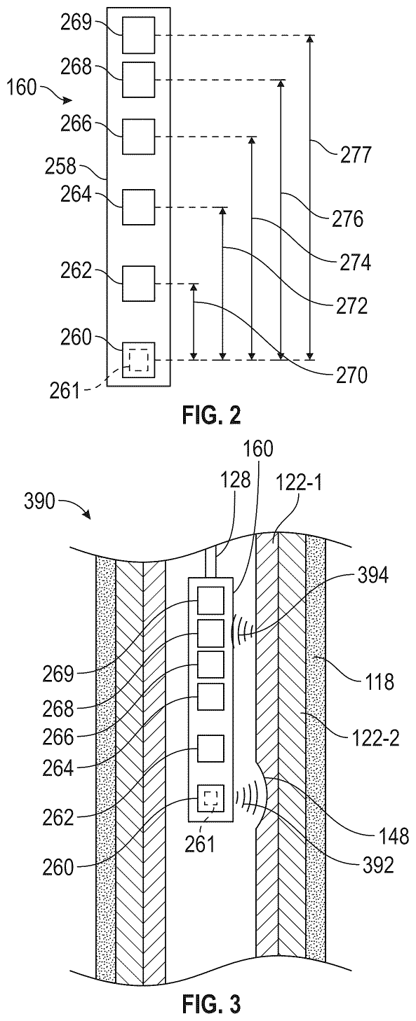

FIG. 2 depicts a schematic diagram of at least a portion of an example implementation of the EM inspection tool 160 that may be utilized for casing and other tubular inspection within the scope of the present disclosure. The EM inspection tool 160 may include a triaxial transmitter 260, one or more collocated triaxial receivers 261, and one or more non-collocated triaxial receivers (e.g., triaxial receivers 262, 264, 266, 268, and 269). The triaxial transmitter 260, the one or more collocated triaxial receivers 261, and the one or more non-collocated triaxial receivers 262, 264, 266, 268, 269 may be enclosed within or otherwise carried with a housing 258. The housing 258 may be a pressure-resistant housing. Note, although FIG. 2 depicts the EM inspection tool 160 with a certain number of triaxial transmitters and a certain number of triaxial receivers, the EM inspection tool 160 may include any number of triaxial transmitters and any number of triaxial receivers.

The triaxial receivers 262, 264, 266, 268, and 269 may be operated based on various magnetic field detection techniques, such as coiled-winding, Hall-effect sensor, giant magneto-resistive sensor, and/or other magnetic field measuring means. The triaxial receivers 262, 264, 266, 268, and 269 may be axially aligned within the EM inspection tool 160, as depicted in the example implementation shown in FIG. 2. In certain embodiments, one or more of the triaxial receivers 262, 264, 266, 268, and 269 may be radially or transversely offset along an axis (e.g., longitudinal axis) of the EM inspection tool 160. For example, one or more of the triaxial receivers 262, 264, 266, 268, and 269 may be azimuthally offset towards or adjacent a perimeter of the EM inspection tool 160. Embodiments within the scope of the present disclosure may also include implementations using triaxial transmitters and/or triaxial receivers in which one or more of the coils of the triaxial transmitters and/or triaxial receivers are transverse or oblique, as in a saddle coil arrangement.

In the example implementation shown in FIG. 2, the one or more collocated triaxial receivers 261 are located at the same location as the triaxial transmitter 260 (at zero distance or spacing from the triaxial transmitter 260), and the one or more non-collocated triaxial receivers 262, 264, 266, 268, and 269 are located at different distances or spacings away from the triaxial transmitter 260. For example, the triaxial receiver 262 is located a distance (or spacing) 270 from the triaxial transmitter 260, the triaxial receiver 264 is located a distance (or spacing) 272 from the triaxial transmitter 260, the triaxial receiver 266 is located a distance (or spacing) 274 from the triaxial transmitter 260, the triaxial receiver 268 is located a distance (or spacing) 276 from the triaxial transmitter 260, and the triaxial receiver 269 is located a distance (or spacing) 277 from the triaxial transmitter 260.

In certain embodiments, the triaxial receivers 262, 264, 26, 268, and 269 may be located at distances (or spacings) of between 0 inches to 40 inches or more from the triaxial transmitter 260. For example, in certain embodiments, at least one of the distances (or spacings) 270, 272, 274, 276, and 277 is within the range of 0 inches to 5 inches from the triaxial transmitter 260; at least another one of the distances (or spacings) 270, 272, 274, 276, and 277 is within the range of 5 inches to 10 inches from the triaxial transmitter 260; at least another one of the distances (or spacings) 270, 272, 274, 276, and 277 is within the range of 20 inches to 30 inches from the triaxial transmitter 260; at least another one of the distances (or spacings) 270, 272, 274, 276, and 277 is within the range of 30 inches to 40 inches from the triaxial transmitter 260; or any combination thereof.

The triaxial receivers 262, 264, 266, 268, and 269 may detect a strength (e.g., signal amplitude) and/or a phase of the returning magnetic field(s) from the casings 122 in different directions (e.g., X (radial) direction, Y (tangential) direction, and Z (axial) direction). The EM inspection tool 160 and/or the data processing system 138 may use detected values (e.g., amplitude and/or phase values) to create a data log. Based on the data log, the EM inspection tool 160 and/or the data processing system 138 may identify and localize, within a geometrical quadrant, the presence of defects 148 within one or more casings 122 utilizing various EM and/or other suitable field-testing analyses. Various techniques, such as inversion, model searching, and simulated annealing, as illustrative, non-limiting examples, may be used to interpret the data log.

FIG. 3 depicts a schematic diagram of an example implementation of the EM inspection tool 160 shown in FIG. 2, according to various embodiments. The example implementation incudes a system 390 for determining quadrant-based locations of defects 148 within the casings 122, based on multi-frequency, non-collocated, induction measurements obtained via the EM inspection tool 160. As the EM inspection tool 160 descends through the casings 122, the triaxial transmitter 260 may be excited by a time-domain pulse excitation and a series of CW multi-frequency excitations. For each excitation frequency, the triaxial transmitter 260 generates a respective time-varying magnetic field 392 in one or more directions (e.g., X (radial) direction, Y (tangential) direction, and Z (axial) direction) that interact with the casings 122 made by certain conductive materials. The time-varying magnetic field(s) 392 travels outward from the triaxial transmitter 260 in the respective X, Y, and Z directions. Each time-varying magnetic field 392 generates eddy currents in the casings 122, which produce corresponding returning magnetic fields 394 in the respective X, Y, and Z directions.

One or more of the non-collocated triaxial receivers 262, 264, 266, 268, and 269 detect multiple returning magnetic fields (in the different directions) excited by time-variant (e.g., decayed) eddy currents in one or more casings 122 and generate a set of multi-frequency, multi-spacing (or non-collocated) data. For example, the returning magnetic fields 394 propagate to the triaxial receivers 262, 264, 266, 268, and 269, which detect the returning magnetic fields 394 in the respective X, Y, and Z directions and convert detection portions of the returning magnetic fields 394 into corresponding signals. In some cases, depending on the distance (or spacing) of the triaxial receiver from the triaxial transmitter 260 and interaction with the defect 148, portions of the returning magnetic fields 394 may arrive at the triaxial receiver with a change in strength (e.g., signal amplitude) relative to when the magnetic fields 394 were induced.

The EM inspection tool 160 may include one or more collocated triaxial receivers (e.g., triaxial receiver 261) and one or more non-collocated triaxial receiver subs (not shown). The quantity of the one or more non-collocated triaxial receiver subs may be any number, such as one, three, ten, or the like. The one or more non-collocated triaxial receiver subs may include any number of non-collocated triaxial receivers. For example, a first non-collocated triaxial receiver sub may include one triaxial receiver, a second non-collocated triaxial receiver sub may include two triaxial receivers, a third non-collocated triaxial receiver sub may include 3 triaxial receivers, and a fourth non-collocated triaxial receiver sub may include 4 triaxial receivers.

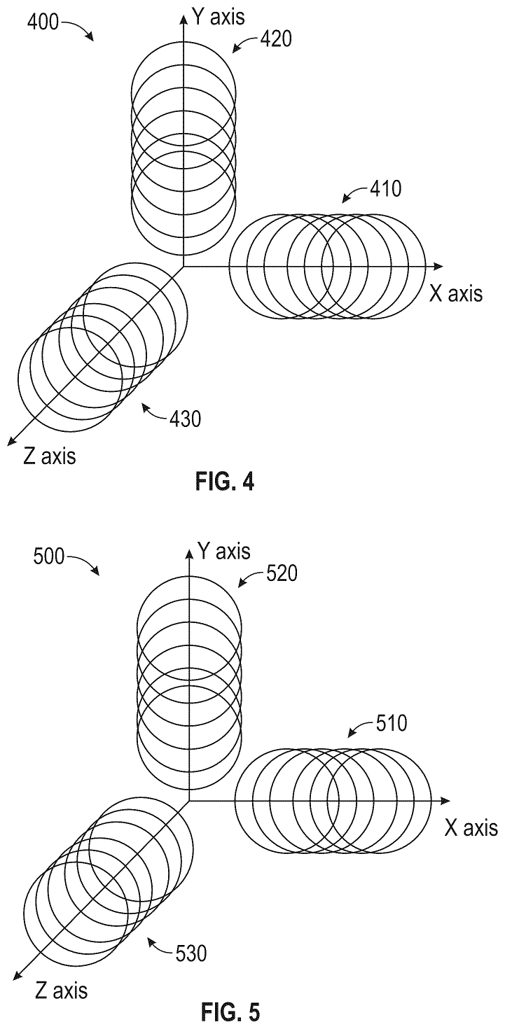

With the foregoing in mind, FIG. 4 illustrates an example triaxial transmitter 400 that may be included within an EM inspection tool 160, according to various embodiments. The triaxial transmitter 400 is an illustrative example of the triaxial transmitter 260 illustrated in FIG. 2. As shown, the triaxial transmitter 400 includes an X Tx coil 410, a Y Tx coil 420, and a Z Tx coil 430. In certain embodiments, the X Tx coil 410 is radially aligned (e.g., with X axis) with respect to the EM inspection tool 160 and is configured to emit one or more primary time-varying magnetic field signals in the X (radial) direction (e.g., along the X axis). In certain embodiments, the Y Tx coil 420 is tangentially aligned (e.g., with Y axis) with respect to the EM inspection tool 160 and is configured to emit one or more primary time-varying magnetic field signals in the Y (tangential) direction (e.g., along the Y axis). In certain embodiments, the Z Tx coil 430 is axially aligned with a longitudinal axis (e.g., Z axis) of the EM inspection tool 160 and is configured to emit one or more primary time-varying magnetic field signals in the Z (axial) direction (e.g., along the Z axis). Note, the EM inspection tool 160 described herein may have a longitudinal axis that is aligned with the Z axis.

As noted, each of the one or more primary time-varying magnetic field signals emitted by the X Tx coil 410, the Y Tx coil 420, and the Z Tx coil 430 may induce a corresponding one or more secondary time-varying magnetic field signals in the X (radial) direction, Y (tangential) direction, and Z (axial) direction, respectively. The primary and/or secondary time-varying magnetic field signals in the different directions may be detected by one or more triaxial receivers.

By way of example, FIG. 5 illustrates an example triaxial receiver 500 that may be included within an EM inspection tool 160, according to various embodiments. The triaxial receiver 500 is an illustrative example of one of the triaxial receivers 261, 262, 264, 266, 268, and 269 illustrated in FIG. 2. As shown, the triaxial receiver 500 includes an X Rx coil 510, a Y Rx coil 520, and a Z Rx coil 530. In certain embodiments, the X Rx coil 510 is radially aligned (e.g., with X axis) with respect to the EM inspection tool 160 and is configured to detect and measure one or more (primary and/or secondary) time-varying magnetic field signals in the X (radial) direction (e.g., along the X axis). In certain embodiments, the Y Rx coil 520 is tangentially aligned (e.g., with Y axis) with respect to the EM inspection tool 160 and is configured to detect and measure one or more (primary and/or secondary) time-varying magnetic field signals in the Y (tangential) direction (e.g., along the Y axis). In certain embodiments, the Z Rx coil 530 is axially aligned with a longitudinal axis (e.g., Z axis) of the EM inspection tool 160 and is configured to detect and measure one or more (primary and/or secondary) time-varying magnetic field signals in the Z (axial) direction (e.g., along the Z axis). As noted, the EM inspection tool 160 described herein may have a longitudinal axis that is aligned with the Z axis.

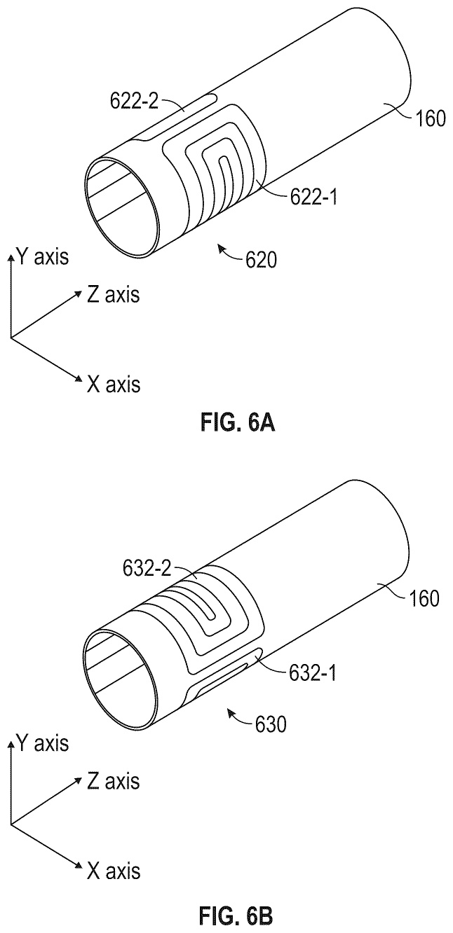

In certain embodiments, each of the X Tx coil 410 and the X Rx coil 510 is implemented using a respective X-directed saddle coil. FIG. 6A illustrates an example X-directed saddle coil 620 that may be used to implement the X Tx coil 410 and the X Rx coil 510 of an EM inspection tool 160, according to various embodiments. As shown, the X-directed saddle coil 620 includes a coil 622-1 and a coil 622-2. The coils 622-1 and 622-2 are disposed on (or adjacent to) opposite sides of a surface of the EM inspection tool 160 and directed in the X direction. The coils 622-1 and 622-2 have opposite polarity magnetic dipoles that may generated by the polarity of current or opposite coil turn windings.

In certain embodiments, each of the Y Tx coil 420 and the Y Rx coil 520 is implemented using a respective Y-directed saddle coil. FIG. 6B illustrates an example Y-directed saddle coil 630 that may be used to implement the Y Tx coil 420 and the Y Rx coil 520 of an EM inspection tool 160, according to various embodiments. As shown, the Y-directed saddle coil 630 includes a coil 632-1 and a coil 632-2. The coils 632-1 and 632-2 are disposed on (or adjacent to) opposite sides of a surface of the EM inspection tool 160 and directed in the Y direction. The coils 632-1 and 632-2 have opposite polarity magnetic dipoles that may generated by the polarity of current or opposite coil turn windings.

Note, the Y-directed saddle coil 630 may be obtained by rotating the X-directed saddle coil 620 by 90° along the surface of the EM inspection tool 160. Similarly, the X-directed saddle coil 620 may be obtained by rotating the Y-directed saddle coil 630 by 90° along the surface of the EM inspection tool 160.

### Example Saddle Coils with Deep Quadrant Sensitivity for Circumferential Imaging of Casings

As noted, certain embodiments herein provide techniques and apparatus for determining quadrant-based locations of casing defects based on multi-frequency, non-collocated, induction measurements obtained via one or more triaxial transmitter-receiver pairs of an EM inspection tool (e.g., EM inspection tool 160).

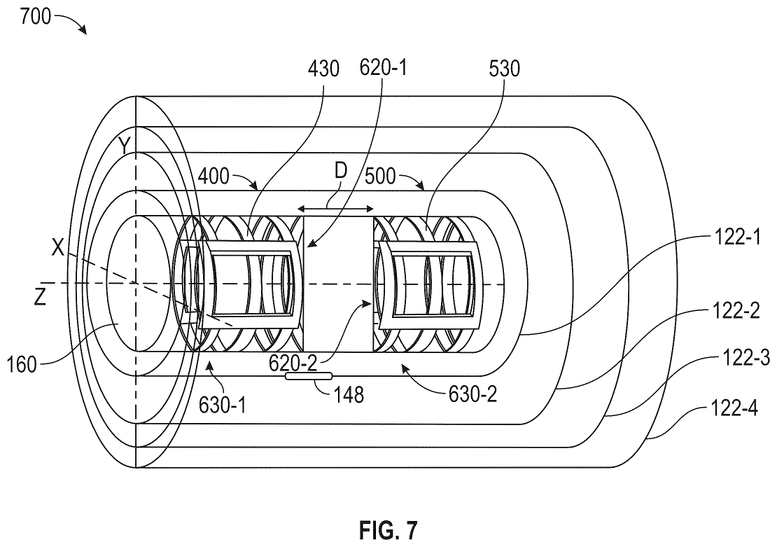

By way of example, FIG. 7 depicts a schematic diagram 700 of at least a portion of an EM inspection tool 160 deployed within at least a portion of a multi-casing well (e.g., wellbore 116) having at least four casings 122-1 to 122-4, according to various embodiments. In the depicted example, casing 122-1 is nested within casings 122-2 to 122-4, casing 122-2 is nested within casings 122-3 to 122-4, and casing 122-3 is nested within casing 122-4. Note, in one or more embodiments, casing 122-1 may be referred to herein as a “first” casing 122, casing 122-2 may be referred to herein as a “second” casing 122, casing 122-3 may be referred to herein as a “third” casing 122, and casing 122-4 may be referred to herein as a “fourth” casing 122.

As shown in FIG. 7, the EM inspection tool 160 includes a triaxial transmitter-receiver pair including, for example, triaxial transmitter 400 and triaxial receiver 500 separated by an axial distance (or spacing) d>0. Note, for the sake of clarity, FIG. 7 depicts a single triaxial transmitter and a single triaxial receiver. However, as noted with respect to FIG. 2, the EM inspection tool 160 may include any number of triaxial transmitters 400 and any number of triaxial receivers 500.

In the depicted embodiment in FIG. 7, the triaxial transmitter 400 includes an X-directed saddle coil 620-1, a Y-directed saddle coil 630-1, and a Z Tx coil 430. Similarly, the triaxial receiver 500 includes an X-directed saddle coil 620-2, a Y-directed saddle coil 630-2, and a Z Rx coil 530. Note, each of the coils depicted in FIG. 7 may have a suitable number of turns to generate or detect a respective magnetic field (having one or more magnetic field signals).

In certain embodiments, the EM inspection tool 160 depicted in FIG. 7 is controlled to measure and generate data including multi-frequency, non-collocated, induction measurements for the casings 122-1 to 122-4. The data that is generated may provide quadrant sensitivity to the location of one or more defects 148 within the casings 122. For example, in certain embodiments, a system (e.g., data processing system 138) can identify and localize, within a geometrical quadrant, the presence of a defect (e.g., defect 148) within one or more casings 122 based on analyzing the multi-frequency, non-collocated, induction measurements obtained via the EM inspection tool 160.

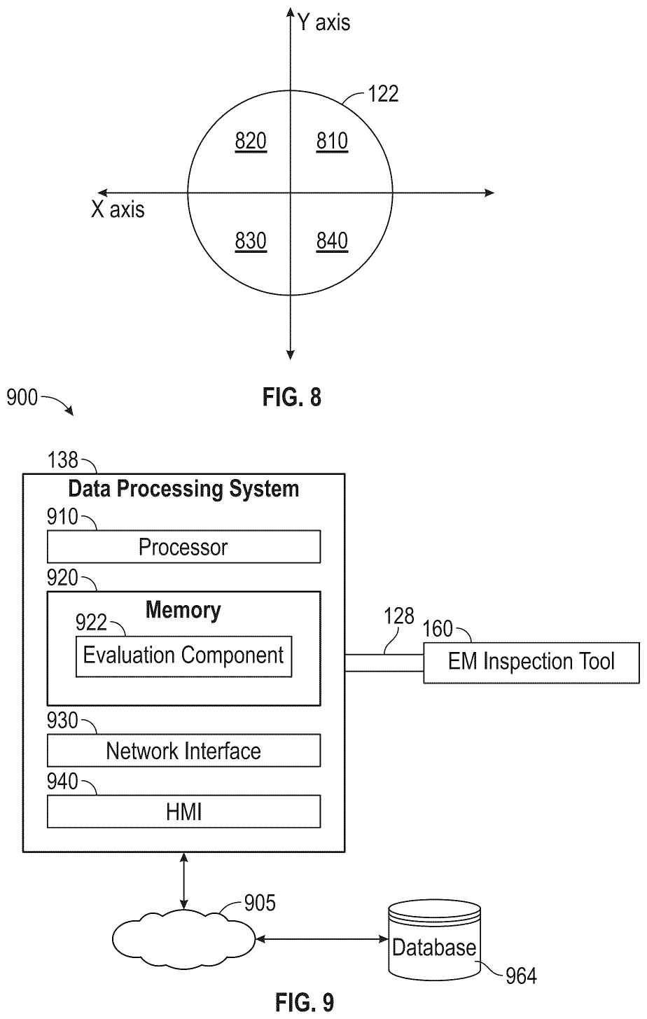

With reference to FIG. 8, for example, the system may determine, for a given defect 148, at a position along the longitudinal axis (e.g., Z axis) of the casing 122, whether the defect 148 is within (and a location of the defect 148 within) the quadrant 810 (e.g., 0° to 90°), quadrant 820 (e.g., 90° to 180°), quadrant 830 (e.g., 180° to 270°), or quadrant 840 (e.g., 270° to 360°), based on the multi-frequency, non-collocated, induction measurements. Note, in certain embodiments, a lateral portion (or sector) of the casing 122 may refer to a 180° portion of the casing 122. For example, a “right” lateral portion of the casing 122 may refer to a combination of quadrants 810 and 840, and “left” lateral portion of the casing 122 may refer to a combination of quadrants 820 and 830.

FIG. 9 is a block diagram of an example system 900 for determining quadrant-based locations of casing defects based on multi-frequency, non-collocated, induction measurements obtained via one or more triaxial transmitter-receiver pairs of an EM inspection tool 160, according to various embodiments. In certain embodiments, the system 900 may be implemented as part of the system 100 depicted in FIG. 1.

As shown, the system 900 includes, without limitation, the data processing system 138, database 964, and EM inspection tool 160. The data processing system 138 and database(s) 1164 may be interconnected via a network 905. The network 905 is representative of a variety of networks, such as a personal area network (PAN) (e.g., a Bluetooth network), a local area network (LAN) (e.g., 802.11 or WiFi network), and a wide area network (WAN) (e.g., cellular network), as illustrative examples.

The data processing system 138 is generally representative of a variety of computing systems, such as laptops, servers, desktops, and mainframes, as illustrative examples. In certain embodiments, the data processing system 138 (including one or more components therein) is located in (or otherwise accessible via) a cloud computing environment. The data processing system 138 may be implemented using hardware, software, or a combination of hardware and software.

The database 964 is generally representative of one or more storage systems configured to store information associated with multi-casing evaluation. For example, the database 964 may store multi-frequency, non-collocated, induction measurements obtained via the EM inspection tool 160. The database 964 may be implemented using hardware, software, or a combination of hardware and software. In certain embodiments, the database 964 is located in (or otherwise accessible via) a cloud computing environment.

As noted, the EM inspection tool 160 may be controlled to measure and generate data including multi-frequency, non-collocated (e.g., multiple spacing), induction measurements for a well having nested casings 122. The EM inspection tool 160 may provide the data to the data processing system 138 via the cable 128.

The data processing system 138 is generally configured to analyze the data obtained via the EM inspection tool 160 to identify and localize, in a geometrical quadrant (e.g., quadrant 810, quadrant 820, quadrant 830, or quadrant 840), the presence of a defect 148 in one or more casings 122 (e.g., casings 122-1 to 122-4) of a multi-casing well. The data processing system 138 may use various techniques, such as inversion, model searching, and simulated annealing, as illustrative, non-limiting examples, to analyze the data. Note, in certain embodiments, the data processing system 138 may retrieve and analyze data including multi-frequency, non-collocated, induction measurements from the database 964. That is, in certain embodiments, information obtained using the EM inspection tool 160 may be stored in the database 964 for later analysis by the data processing system 138.

As shown, the data processing system 138 includes, without limitation, a processor 910, a memory 920, a network interface 930, and a human machine interface (HMI) 940. The processor 910 represents any number of processing elements, which can include any number of processing cores. The memory 920 can include volatile memory, non-volatile memory, and combinations thereof. The memory 920 generally includes program code (e.g., evaluation component 922) for performing various techniques described herein for determining quadrant-based locations of casing defects, based on evaluating multi-frequency, non-collocated, induction measurements obtained via an EM inspection tool 160. The program code is generally described as various functional “components” or “modules” within the memory 920, although alternate implementations may have different functions or combinations of functions.

The network interface 930 may include circuitry for communicating over the network 905. For example, the network interface 930 may include interfaces for PAN, LAN, and/or WAN, as illustrative examples. The HMI 940 may include one or more input and/or output devices for enabling communication between the processor 910, the memory 920, the network interface 930, and one or more users. In certain embodiments, the HMI 940 includes one or more input devices, one or more output devices, or a combination thereof. For example, the HMI 940 may include a display and/or a keyboard, a mouse, a touch pad, or other input devices suitable for receiving inputs from a user. In certain embodiments, the HMI 940 includes a touch-screen display (e.g., touch screen liquid crystal display (LCD)), which may enable users to interact with a user interface of the data processing system 138.

In certain embodiments, for each triaxial transmitter-receiver pair (e.g., triaxial transmitter-receiver pair depicted in FIG. 7), the induction measurements include a respective set of magnitude and/or phase measurements associated with each cross coupling combination of the triaxial transmitter coils with the triaxial receiver coils. For example, for each triaxial transmitter-receiver pair, the induction measurements may include respective magnitude and/or phase measurements from (i) a cross coupling of the X Tx coil 410 with the X Rx coil 510 (referred to herein as an “XX cross coupling”), (ii) a cross coupling of the X Tx coil 410 with the Y Rx coil 520 (referred to herein as an “XY cross coupling”), (iii) a cross coupling of the X Tx coil 410 with the Z Rx coil 530 (referred to herein as an “XZ cross coupling”), (iv) a cross coupling of the Y Tx coil 420 with the X Rx coil 510 (referred to herein as an “YX cross coupling”), (v) a cross coupling of the Y Tx coil 420 with the Y Rx coil 520 (referred to herein as an “YY cross coupling”), (vi) a cross coupling of the Y Tx coil 420 with the Z Rx coil 530 (referred to herein as an “YZ cross coupling”), (vii) a cross coupling of the Z Tx coil 430 with the X Rx coil 510 (referred to herein as an “ZX cross coupling”), (viii) a cross coupling of the Z Tx coil 430 with the Y Rx coil 520 (referred to herein as an “ZY cross coupling”), (ix) a cross coupling of the Z Tx coil 430 with the Z Rx coil 530 (referred to herein as an “ZZ cross coupling”), or (x) any combination thereof.

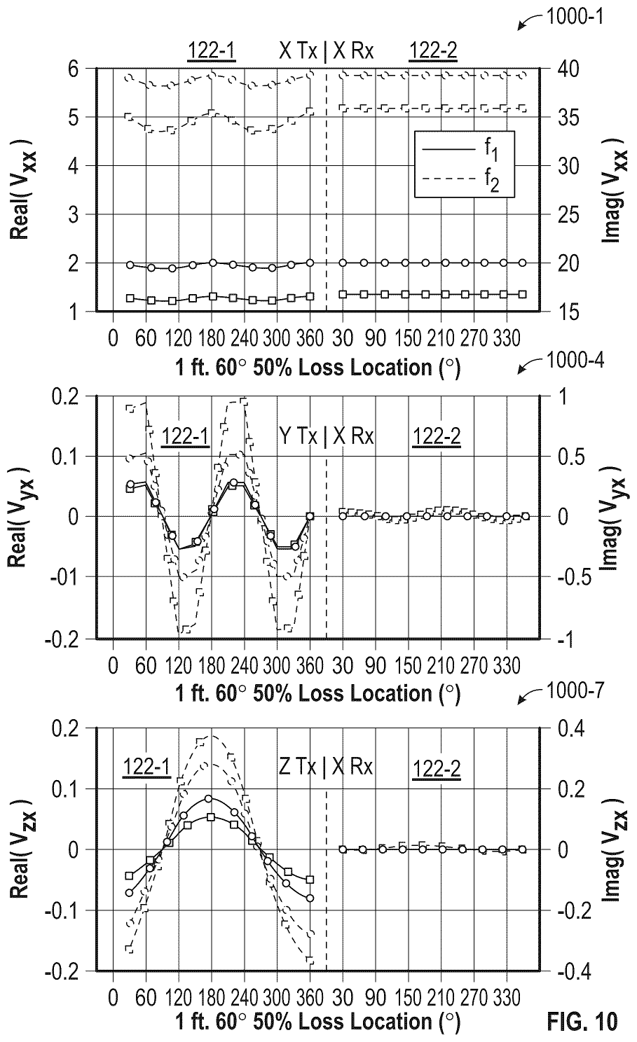

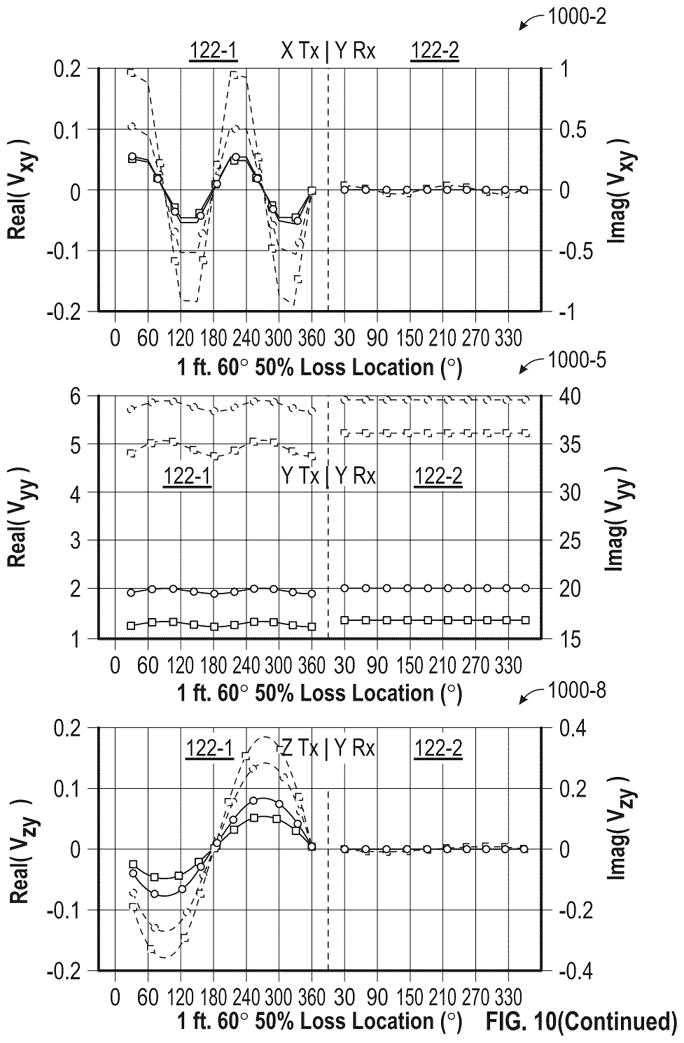

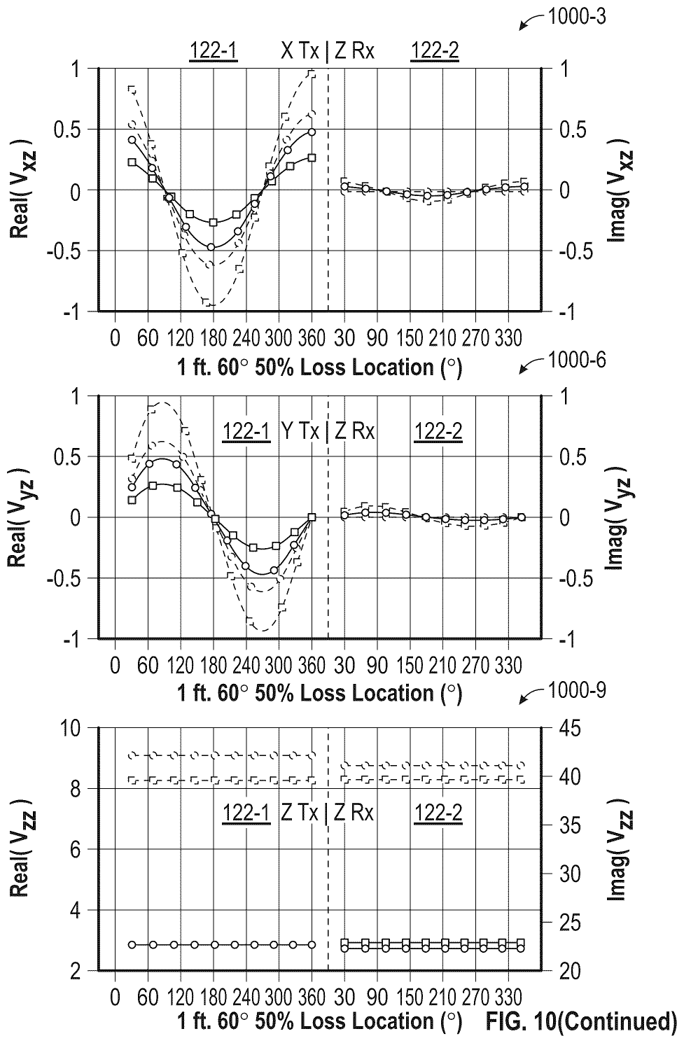

Consider FIG. 10, which depicts graphs 1000-1 to 1000-9 illustrating real and imaginary components of responses (e.g., voltage (V) magnitudes) from cross couplings of coils of a triaxial transmitter 400 with coils of a triaxial receiver 500 for a two-casing configuration, according to various embodiments. In particular, graphs 1000-1 to 1000-9 show the sensitivity of each of nine triaxial cross couplings for a triaxial transmitter-receiver pair (separated by an axial distance (or spacing) d₁>0 (e.g., approximately 5 inches)) as a function of location of a defect (e.g., defect 148) on a “first” casing 122-1 and a “second” casing 122-2, respectively, for multiple excitation frequencies (f₁ and f₂, where 0<f₁<f₂). For example, graph 1000-1 indicates the sensitivity for the XX cross coupling, graph 1000-2 indicates the sensitivity for the XY cross coupling, graph 1000-3 indicates the sensitivity for the XZ cross coupling, graph 1000-4 indicates the sensitivity for the YX cross coupling, graph 1000-5 indicates the sensitivity for the YY cross coupling, graph 1000-6 indicates the sensitivity for the YZ cross coupling, graph 1000-7 indicates the sensitivity for the ZX cross coupling, graph 1000-8 indicates the sensitivity for the ZY cross coupling, and graph 1000-9 indicates the sensitivity for the ZZ cross coupling.

In FIG. 10, the real components are indicated using (solid and dashed) lines with squares, and the imaginary components are indicated using (solid and dashed) lines with circles. The “first” casing 122-1 has an outer diameter (OD) approximately equal to OD₁ and the “second” casing has an OD approximately equal to OD₂, where 0<OD₁<OD₂. Here, the defect is a 1 foot long, 50% loss (of casing thickness, Δ) patch with 60° aperture on the outer surface of each casing 122-1 to 122-2. Note, however, that this is merely an example and that the type and/or size of defect may be different in other scenarios.

In FIG. 10, the horizontal axis in each graph 1000-1 to 1000-9 shows the location of the defect (e.g., lossy patch) on the casings 122-1 and 122-2. The location of the defect is changed from 0°-360° in steps of 30° individually along each casing 122 while keeping nominal thickness for other casings. The first set of 0°-360° locations corresponds to the locations of the defect on the “first” casing 122-1 and the second set of 0°-360° locations corresponds to the locations of the defect on the “second” casing 122-2.

As shown in FIG. 10, the self-dipole XX cross coupling (e.g., graph 1000-1) and the self-dipole YY cross coupling (e.g., graph 1000-5) have the strongest responses and may show a lateral sensitivity to the location of the defect. As indicated in graph 1000-9, the self-dipole ZZ cross coupling is sensitive to the averaged metal loss over the circumference of the casings 122, but does not provide any azimuthal (or quadrant) sensitivity.

As shown in FIG. 10, at this particular spacing (e.g., d₁) for the triaxial transmitter-receiver pair, the “first” casing defect has a greater impact on the sensitivity of the cross couplings than the “second” casing defect. The XY and YX cross (dipole) couplings indicated in graph 1000-2 and graph 1000-4, respectively, have cos(2θ) sensitivity to the location of the defect, while the XZ and YZ cross couplings indicated in graph 1000-3 and graph 1000-6, respectively, have cos(θ) sensitivity to the location of the defect. Accordingly, for triaxial transmitter-receiver spacings less than or equal to d₁, the (i) magnitude value from the XY cross coupling and/or the YX cross coupling and (ii) sign (e.g., positive or negative) from the XZ cross coupling and/or the YZ cross coupling may distinctively provide the quadrant sensitivity to the defect location for the “first” casing 122-1.

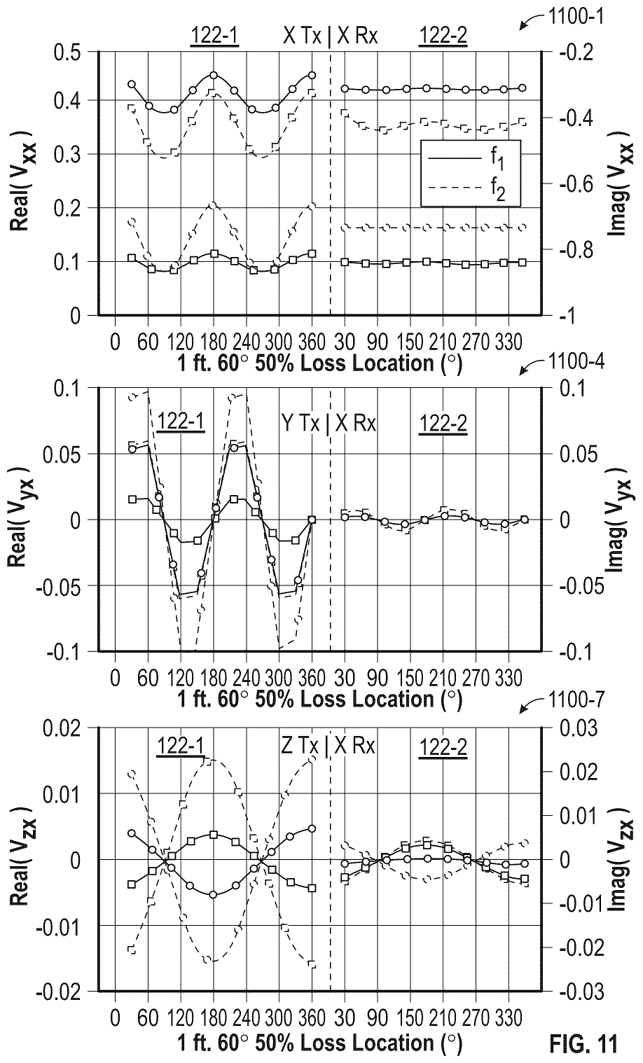

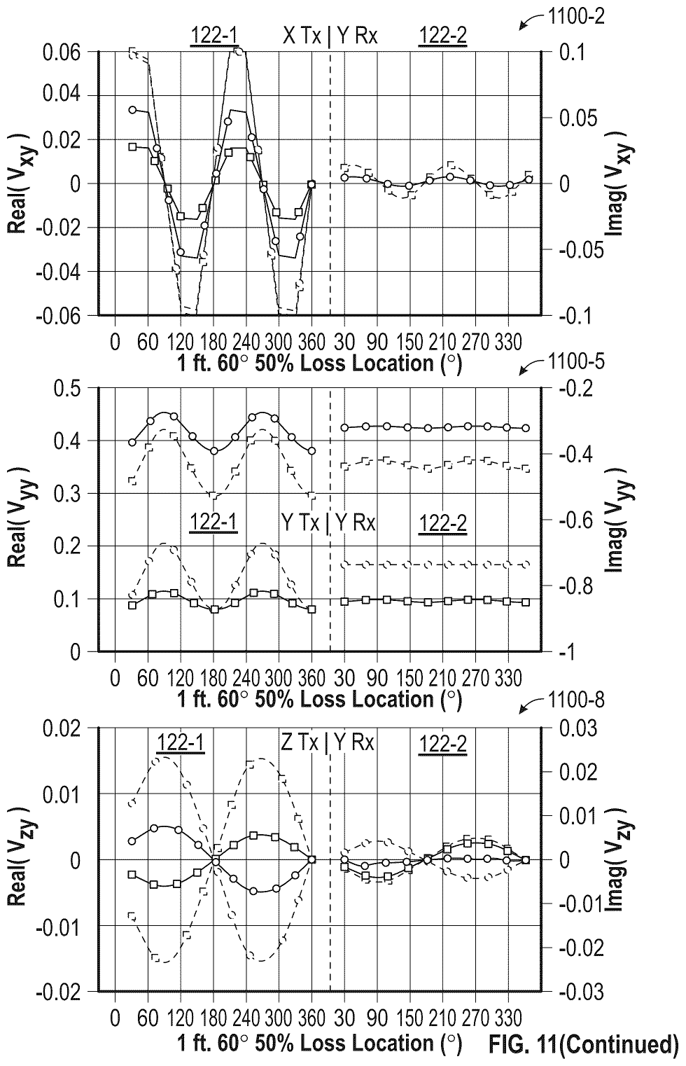

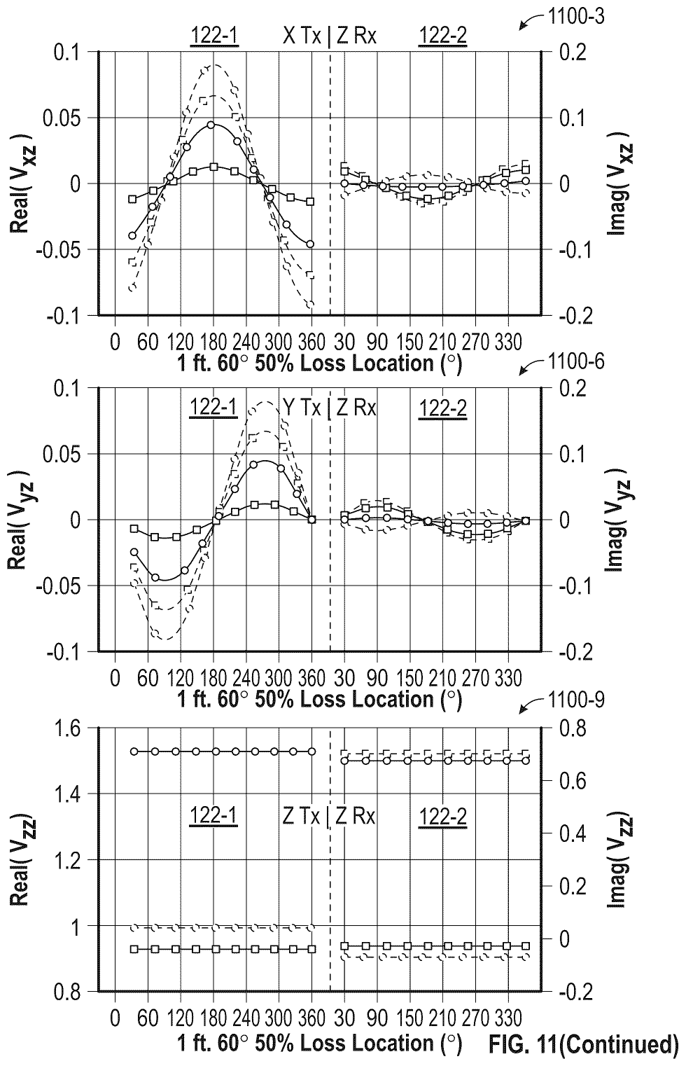

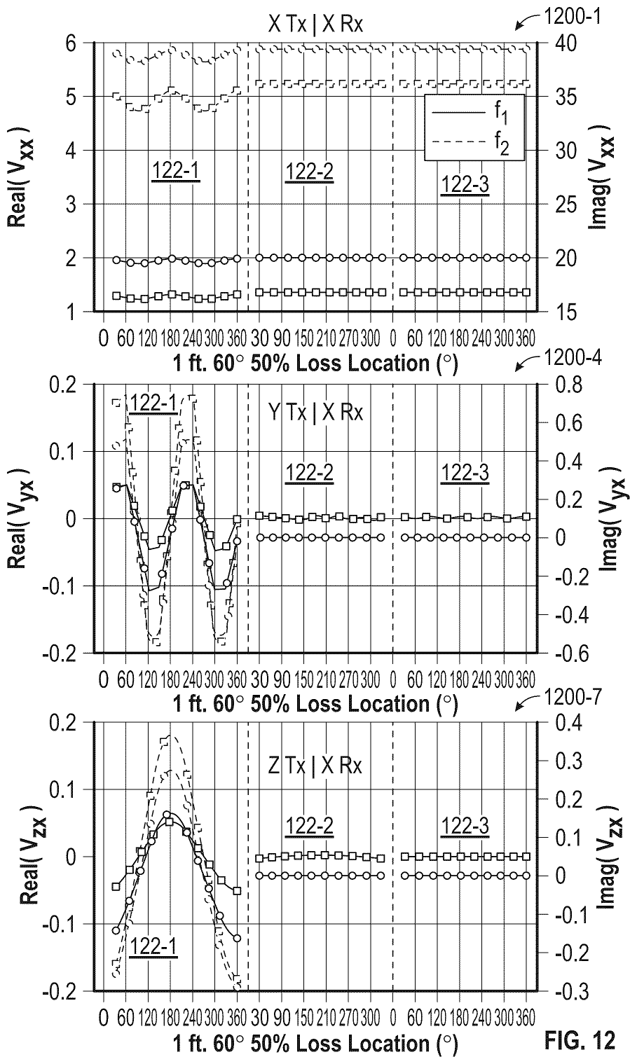

FIG. 11 depicts graphs 1100-1 to 1100-9 illustrating real and imaginary components of responses (e.g., voltage (V) magnitudes) from cross couplings of coils of a triaxial transmitter with coils of a triaxial receiver for a two-casing configuration, according to various embodiments. In particular, graphs 1100-1 to 1100-9 show the sensitivity of each of nine triaxial cross couplings for a triaxial transmitter-receiver pair (separated by an axial distance (or spacing) d₂>d₁ (e.g., d₂≈10 inches)) as a function of location of a defect (e.g., defect 148) on a “first” casing 122-1 and a “second” casing 122-2, respectively, for multiple excitation frequencies (f₁ and f₂, where 0<f₁<f₂). For example, graph 1100-1 indicates the sensitivity for the XX cross coupling, graph 1100-2 indicates the sensitivity for the XY cross coupling, graph 1100-3 indicates the sensitivity for the XZ cross coupling, graph 1100-4 indicates the sensitivity for the YX cross coupling, graph 1100-5 indicates the sensitivity for the YY cross coupling, graph 1100-6 indicates the sensitivity for the YZ cross coupling, graph 1100-7 indicates the sensitivity for the ZX cross coupling, graph 1100-8 indicates the sensitivity for the ZY cross coupling, and graph 1100-9 indicates the sensitivity for the ZZ cross coupling.

In FIG. 11, the real components are indicated using (solid and dashed) lines with squares, and the imaginary components are indicated using (solid and dashed) lines with circles. The “first” casing 122-1 has an OD approximately equal to ODI and the “second” casing has an OD approximately equal to OD₂, where 0<OD₁<OD₂. Here, the defect is a 1 foot long, 50% loss (of casing thickness, Δ) patch with 60° aperture on the outer surface of each casing 122-1 to 122-2. Note, however, that this is merely an example and that the type and/or size of defect may be different in other scenarios.

In FIG. 11, the horizontal axis in each graph 1100-1 to 1100-9 shows the location of the defect (e.g., lossy patch) on the casings 122-1 and 122-2. The location of the defect is changed from 0°-360° in steps of 30° individually along each casing 122 while keeping nominal thickness for other casings. The first set of 0°-360° locations corresponds to the locations of the defect on the “first” casing 122-1 and the second set of 0°-360° locations corresponds to the locations of the defect on the “second” casing 122-2.

Similar to FIG. 10, as shown in FIG. 11, the self-dipole XX cross coupling (e.g., graph 1100-1) and the self-dipole YY cross coupling (e.g., graph 1100-5) have the strongest responses and may show a lateral sensitivity to the location of the defect. Additionally, similar to FIG. 10, as indicated in graph 1100-9 of FIG. 11, the self-dipole ZZ cross coupling is sensitive to the averaged metal loss over the circumference of the casings 122, but does not provide any azimuthal (or quadrant) sensitivity.

However, as shown in FIG. 11, there is a stronger sensitivity to the “second” casing defect at this particular spacing (e.g., d₂) for the triaxial transmitter-receiver pair compared to the sensitivity to the “second” casing defect at the triaxial transmitter-receiver spacing of d₁ shown in FIG. 10. As shown, similar to FIG. 10, the XY and YX cross (dipole) couplings indicated in graph 1100-2 and graph 1100-4, respectively, have cos(2θ) sensitivity to the location of the defect, while the XZ and YZ cross couplings indicated in graph 1100-3 and graph 1100-6, respectively, have cos(θ) sensitivity to the location of the defect. Thus, for two-casing configurations, for triaxial transmitter-receiver spacings at d₂, the (i) magnitude value from the XY cross coupling and/or the YX cross coupling and (ii) sign (e.g., positive or negative) from the XZ cross coupling and/or YZ cross coupling may distinctively provide the quadrant sensitivity to the defect location for the “first” casing 122-1 and the “second” casing 122-2.

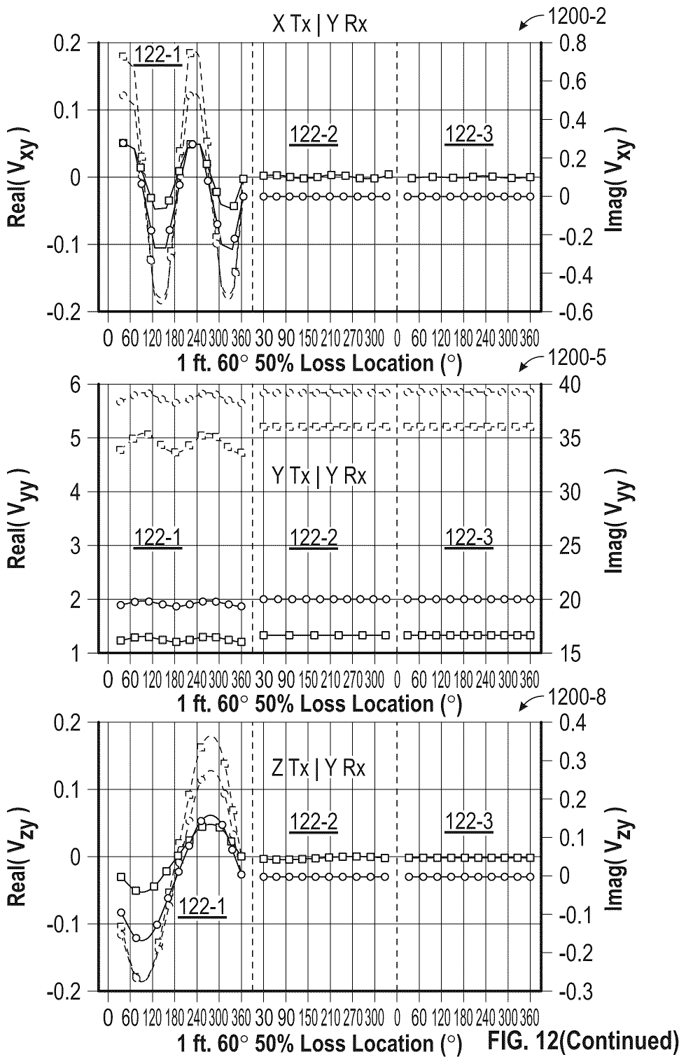

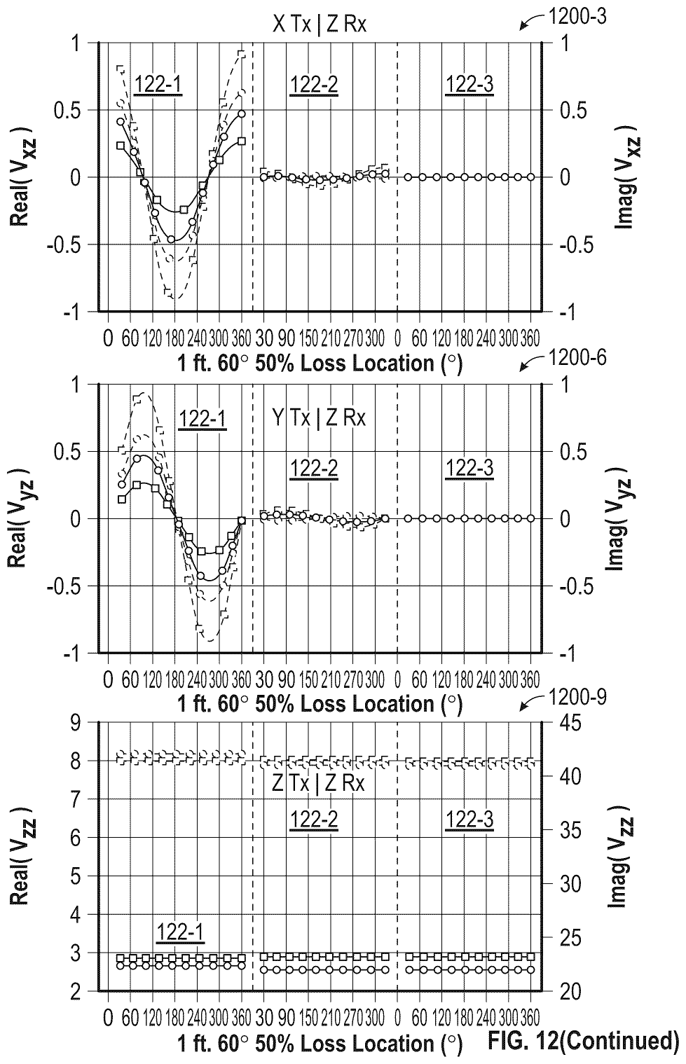

FIG. 12 depicts graphs 1200-1 to 1200-9 illustrating real and imaginary components of responses (e.g., voltage (V) magnitudes) from cross couplings of coils of a triaxial transmitter with coils of a triaxial receiver for a three-casing configuration, according to various embodiments. In particular, graphs 1200-1 to 1200-9 show the sensitivity of each of nine triaxial cross couplings for a triaxial transmitter-receiver pair (separated by an axial distance (or spacing) d₁>0 (e.g., d₁≈5 inches)) as a function of location of a defect (e.g., defect 148) on a “first” casing 122-1, “second” casing 122-2, and “third” casing 122-3, respectively, for multiple excitation frequencies (f₁ and f₂, where 0<f₁<f₂). For example, graph 1200-1 indicates the sensitivity for the XX cross coupling, graph 1200-2 indicates the sensitivity for the XY cross coupling, graph 1200-3 indicates the sensitivity for the XZ cross coupling, graph 1200-4 indicates the sensitivity for the YX cross coupling, graph 1200-5 indicates the sensitivity for the YY cross coupling, graph 1200-6 indicates the sensitivity for the YZ cross coupling, graph 1200-7 indicates the sensitivity for the ZX cross coupling, graph 1200-8 indicates the sensitivity for the ZY cross coupling, and graph 1200-9 indicates the sensitivity for the ZZ cross coupling.

In FIG. 12, the real components are indicated using (solid and dashed) lines with squares, and the imaginary components are indicated using (solid and dashed) lines with circles. The “first” casing 122-1 has an OD approximately equal to OD₁, the “second” casing has an OD approximately equal to OD₂, and the “third” casing has an OD approximately equal to OD₃, where 0<OD₁<OD₂<OD₃. Here, the defect is a 1 foot long, 50% loss (of casing thickness, Δ) patch with 60° aperture on the outer surface of each casing 122-1 to 122-3. Note, however, that this is merely an example and that the type and/or size of defect may be different in other scenarios.

In FIG. 12, the horizontal axis in each graph 1200-1 to 1200-9 shows the location of the defect (e.g., lossy patch) on the casings 122-1, 122-2, and 122-3. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, and the third set of 0°-360° locations corresponds to the locations of the defect on the “third” casing 122-3.

Similar to FIGS. 10-11, as shown in FIG. 12, the self-dipole XX cross coupling (e.g., graph 1200-1) and the self-dipole YY cross coupling (e.g., graph 1200-5) have the strongest responses and may show a lateral sensitivity to the location of the defect. Additionally, similar to FIGS. 10-11, as indicated in graph 1200-9 of FIG. 12, the ZZ self-dipole cross coupling is sensitive to the averaged metal loss over the circumference of the casings 122, but does not provide any azimuthal (or quadrant) sensitivity.

Similar to FIG. 10, as shown in FIG. 12, at this particular spacing (e.g., d₁) for the triaxial transmitter-receiver pair, the “first” casing defect has a greater impact on the sensitivity of the cross couplings than the “second” casing defect and the “third” casing defect. Here, for three-casing configurations, for triaxial transmitter-receiver spacings less than or equal to d₁, the cross (dipole) couplings with cos(2θ) sensitivity to the location of the defect (e.g., XY and YX cross couplings indicated in graph 1200-2 and in graph 1200-4, respectively) and the cross couplings with cos(θ) sensitivity to the location of the defect (e.g., XZ and YZ cross couplings indicated in graph 1200-3 and graph 1200-6, respectively) may distinctively provide the quadrant sensitivity to the defect location for the “first” casing 122-1.

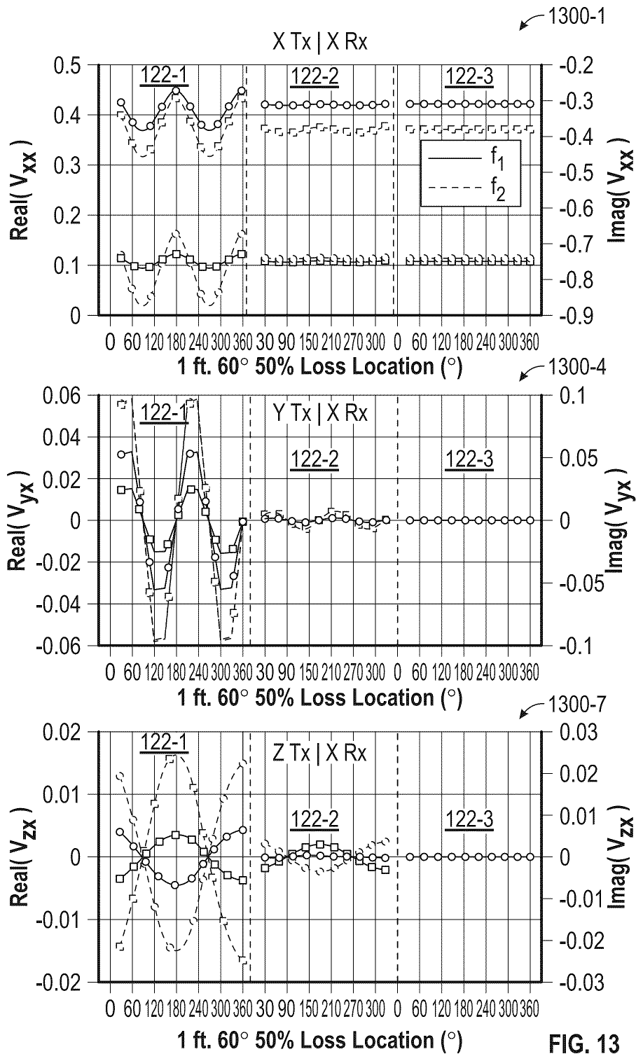

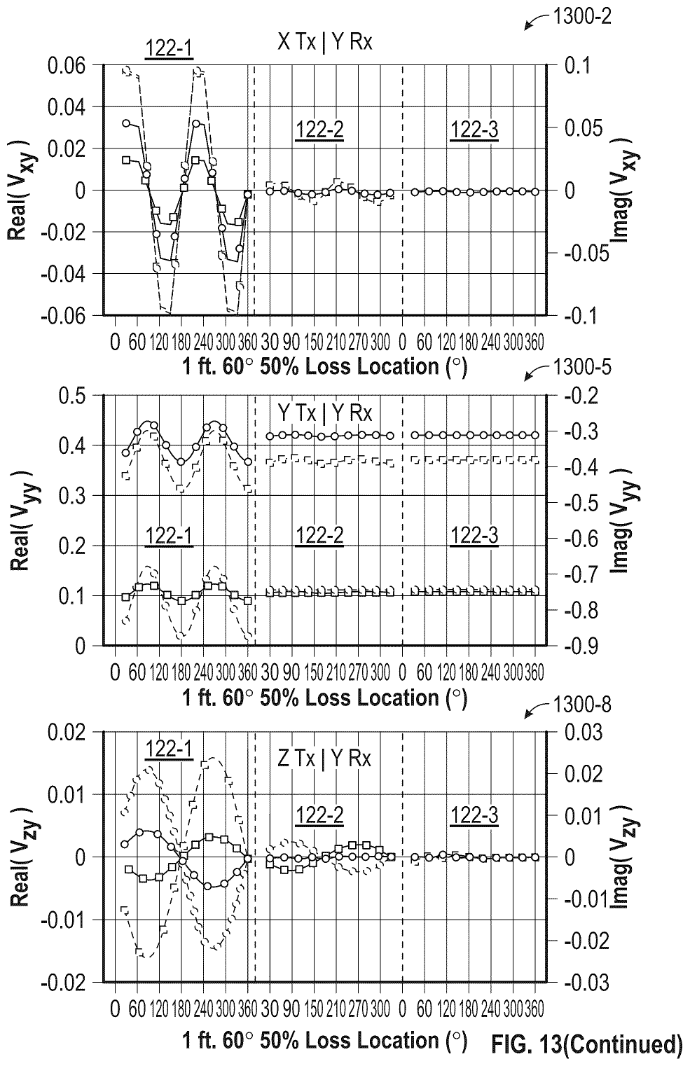

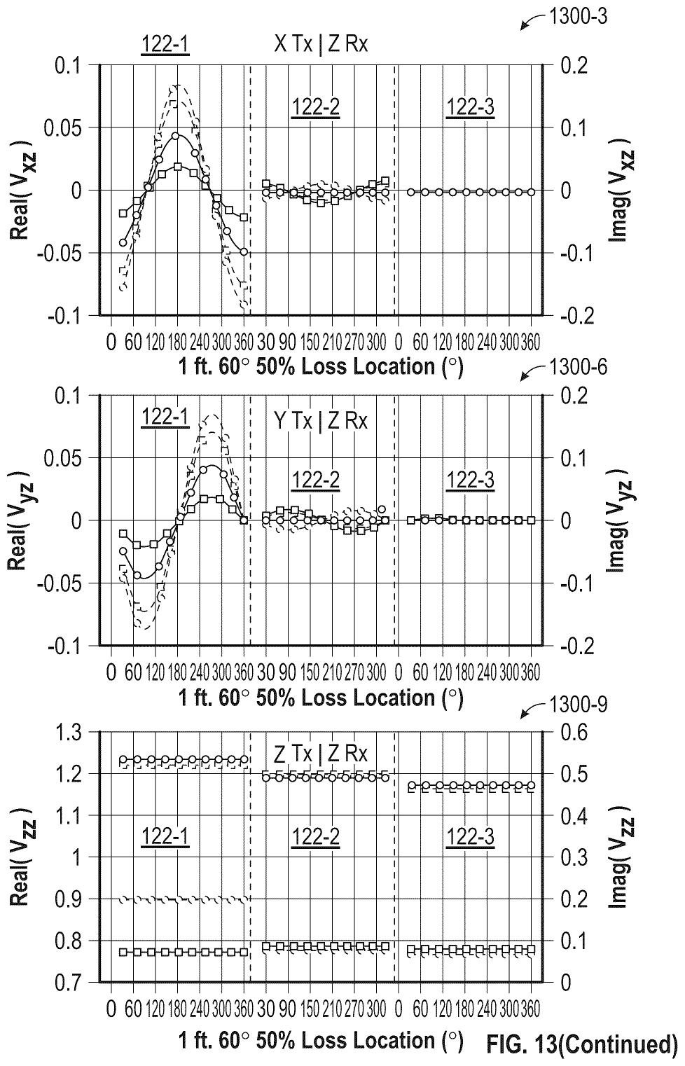

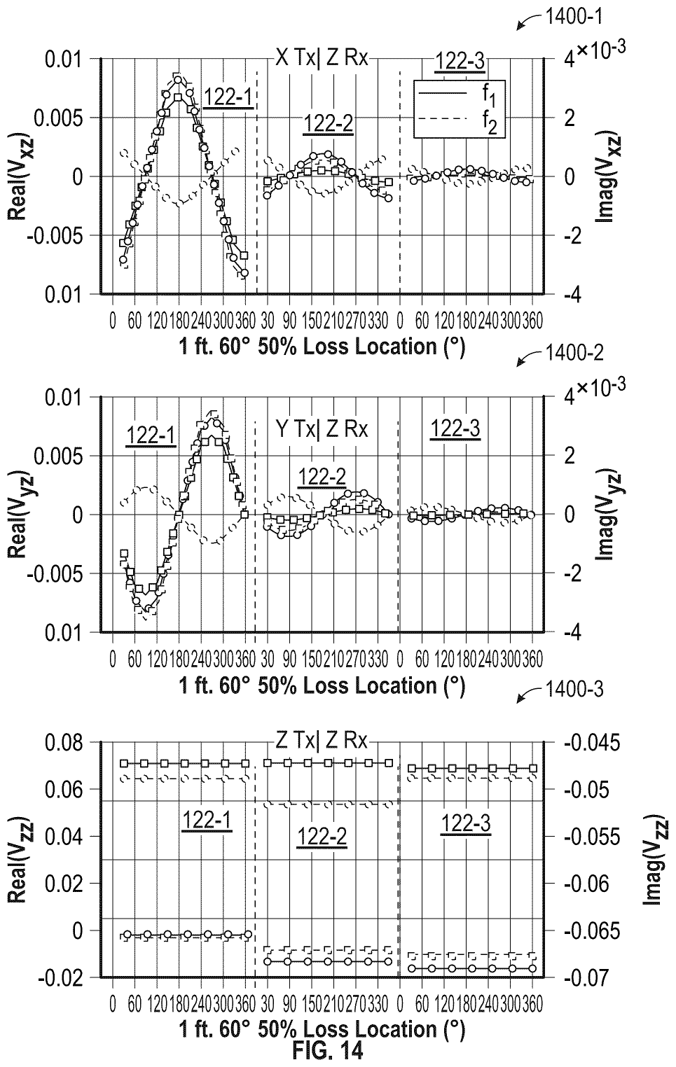

FIG. 13 depicts graphs 1300-1 to 1300-9 illustrating real and imaginary components of responses (e.g., voltage (V) magnitudes) from cross couplings of coils of a triaxial transmitter with coils of a triaxial receiver for a three-casing configuration, according to various embodiments. In particular, graphs 1300-1 to 1300-9 show the sensitivity of each of nine triaxial cross couplings for a triaxial transmitter-receiver pair (separated by an axial distance (or spacing) d₂ (e.g., d₂≈10 inches)) as a function of location of a defect (e.g., defect 148) on a “first” casing 122-1, “second” casing 122-2, and “third” casing 122-3, respectively, for multiple excitation frequencies (f₁ and f₂, where 0<f₁<f₂). For example, graph 1300-1 indicates the sensitivity for the XX cross coupling, graph 1300-2 indicates the sensitivity for the XY cross coupling, graph 1300-3 indicates the sensitivity for the XZ cross coupling, graph 1300-4 indicates the sensitivity for the YX cross coupling, graph 1300-5 indicates the sensitivity for the YY cross coupling, graph 1300-6 indicates the sensitivity for the YZ cross coupling, graph 1300-7 indicates the sensitivity for the ZX cross coupling, graph 1300-8 indicates the sensitivity for the ZY cross coupling, and graph 1300-9 indicates the sensitivity for the ZZ cross coupling.

In FIG. 13, the real components are indicated using (solid and dashed) lines with squares, and the imaginary components are indicated using (solid and dashed) lines with circles. The “first” casing 122-1 has an OD approximately equal to OD₁, the “second” casing has an OD approximately equal to OD₂, and the “third” casing has an OD approximately equal to OD₃, where 0<OD₁<OD₂<OD₃. Here, the defect is a 1 foot long, 50% loss (of casing thickness, Δ) patch with 60° aperture on the outer surface of each casing 122-1 to 122-3. Note, however, that this is merely an example and that the type and/or size of defect may be different in other scenarios.

In FIG. 13, the horizontal axis in each graph 1300-1 to 1300-9 shows the location of the defect (e.g., lossy patch) on the casings 122-1, 122-2, and 122-3. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, and the third set of 0°-360° locations corresponds to the locations of the defect on the “third” casing 122-3.

As shown in FIG. 13, there is a stronger sensitivity to the “second” casing defect at the triaxial transmitter-receiver spacing of d₂ compared to the sensitivity to the “second” casing defect at the triaxial transmitter-receiver spacing of d₁ shown in FIG. 12. Thus, in certain embodiments, for three-casing configurations, for triaxial transmitter-receiver spacings greater than or equal to d₁ and less than or equal to d₂, the cross (dipole) couplings with cos(2θ) sensitivity to the location of the defect (e.g., XY and YX cross couplings indicated in graph 1300-2 and graph 1300-4, respectively) and the cross couplings with cos(θ) sensitivity to the location of the defect (e.g., XZ and YZ cross couplings indicated in graph 1300-3 and graph 1300-6, respectively) may distinctively provide the quadrant sensitivity to the defect location for the “first” casing 122-1 and the “second” casing 122-2.

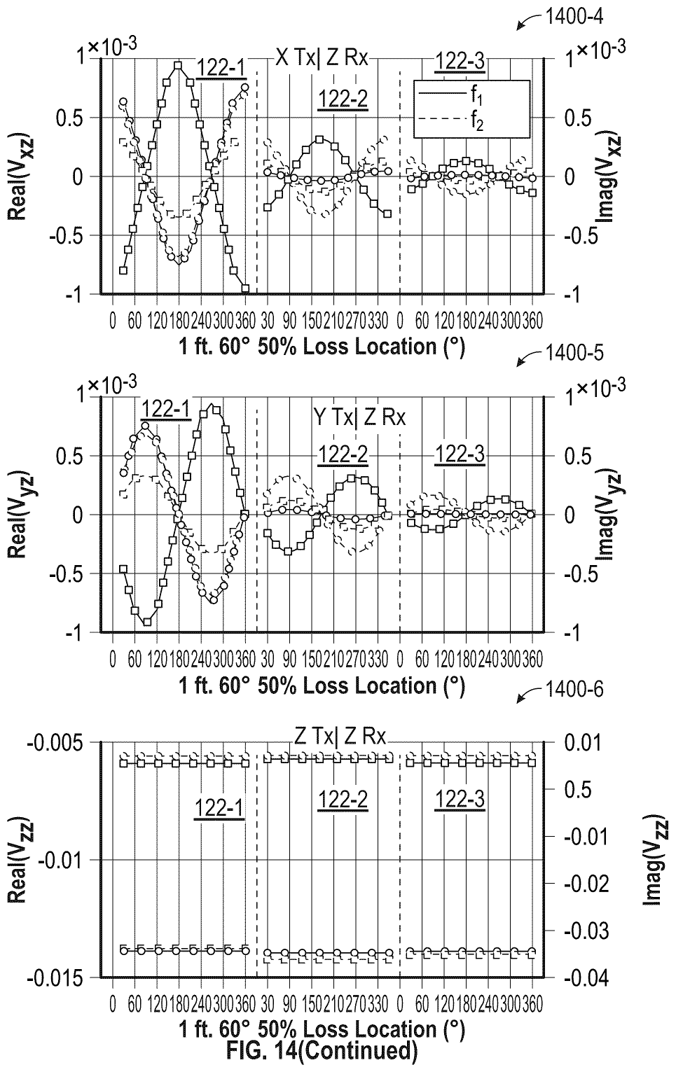

In some cases, the XY cross coupling and/or YX cross coupling may attenuate faster along the length of the casing 122 than other cross couplings. For spacings of 20 inches and more, the XZ cross coupling and/or YZ cross coupling may have the strongest responses among the nine cross couplings. By way of example, FIG. 14 depicts graphs 1400-1 to 1400-6 illustrating real and imaginary components of responses (e.g., voltage (V) magnitudes) from certain cross couplings of coils of a triaxial transmitter with coils of a triaxial receiver for a three-casing configuration, according to various embodiments.

In particular, graphs 1400-1 to 1400-3 indicate the sensitivities for the XZ cross coupling, the YZ cross coupling, and the ZZ cross coupling, respectively, for a triaxial transmitter-receiver pair (separated by an axial distance (or spacing) d₃>d₂ (e.g., d₃≈20 inches)) as a function of location of a defect (e.g., defect 148) on a “first” casing 122-1, “second” casing 122-2, and “third” casing 122-3, respectively, for multiple excitation frequencies (f₁ and f₂, where 0<f₁<f₂). Similarly, graphs 1400-4 to 1400-6 indicate the sensitivities for the XZ cross coupling, the YZ cross coupling, and the ZZ cross coupling, respectively, for a triaxial transmitter-receiver pair (separated by an axial distance (or spacing) d₄>d₃ (e.g., d₄≈30 inches)) as a function of location of a defect (e.g., defect 148) on a “first” casing 122-1, “second” casing 122-2, and “third” casing 122-3, respectively, for multiple excitation frequencies (f₁ and f₂, where 0<f₁<f₂).

In FIG. 14, the real components are indicated using (solid and dashed) lines with squares, and the imaginary components are indicated using (solid and dashed) lines with circles. The “first” casing 122-1 has an OD approximately equal to OD₁, the “second” casing has an OD approximately equal to OD₂, and the “third” casing has an OD approximately equal to OD₃, where 0<OD₁<OD₂<OD₃. Here, the defect is a 1 foot long, 50% loss (of casing thickness, Δ) patch with 60° aperture on the outer surface of each casing 122-1 to 122-3. Note, however, that this is merely an example and that the type and/or size of defect may be different in other scenarios.

In FIG. 14, the horizontal axis in each graph 1400-1 to 1400-6 shows the location of the defect (e.g., lossy patch) on the casings 122-1, 122-2, and 122-3. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, and the third set of 0°-360° locations corresponds to the locations of the defect on the “third” casing 122-3.

As indicated in graphs 1400-1, 1400-2, 1400-4 and 1400-5 of FIG. 14, there is stronger sensitivity to the “second” and “third” casing defects at triaxial transmitter-receiver spacings of d₃ and d₄, compared to the sensitivity to the “second” and “third” casing defects at triaxial transmitter-receiver spacings of d₁ and d₂ shown in FIGS. 12 and 13, respectively. Accordingly, at triaxial transmitter-receiver spacings of at least d₃, the sensitivities to the “second” and “third” casing defects (e.g., as indicated in graphs 1400-1, 1400-2, 1400-4, and 1400-5) may provide left-right or lateral sensitivity to the location of an azimuthally located casing defect in the “second” and/or “third” casings 122.

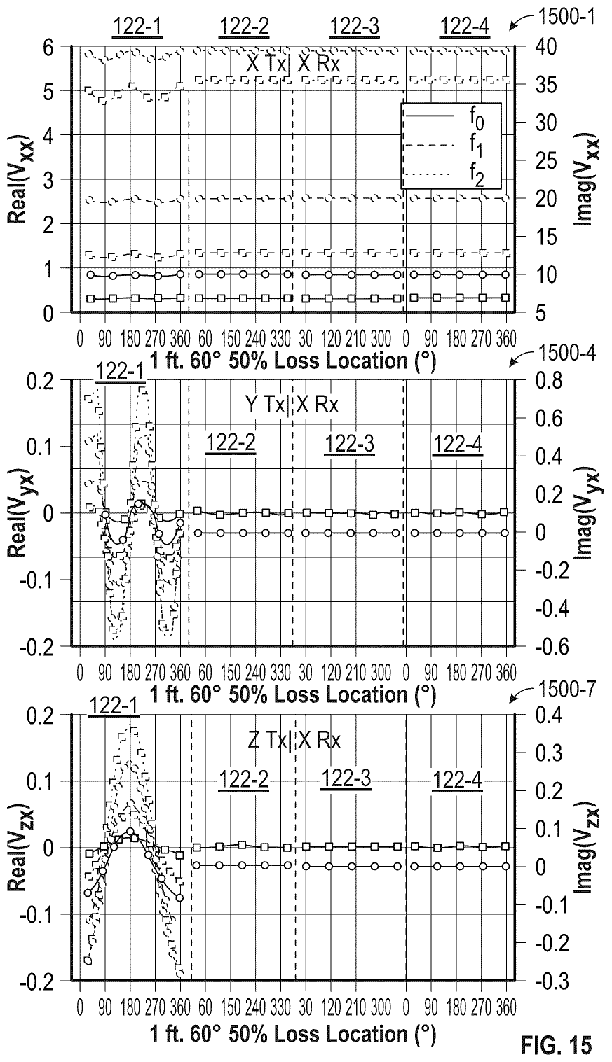

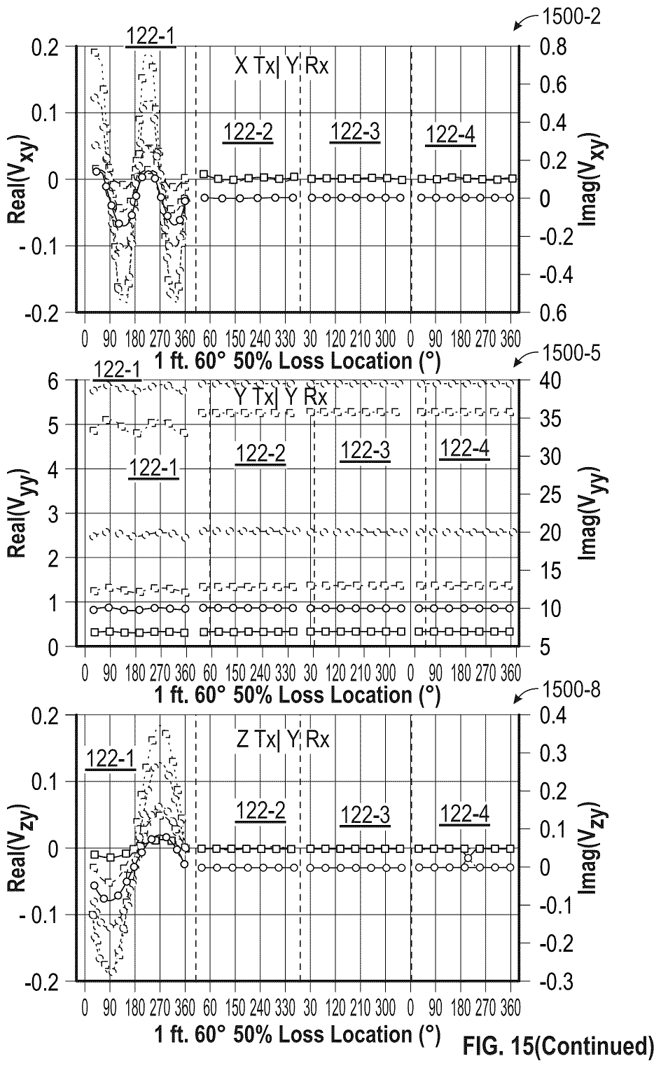

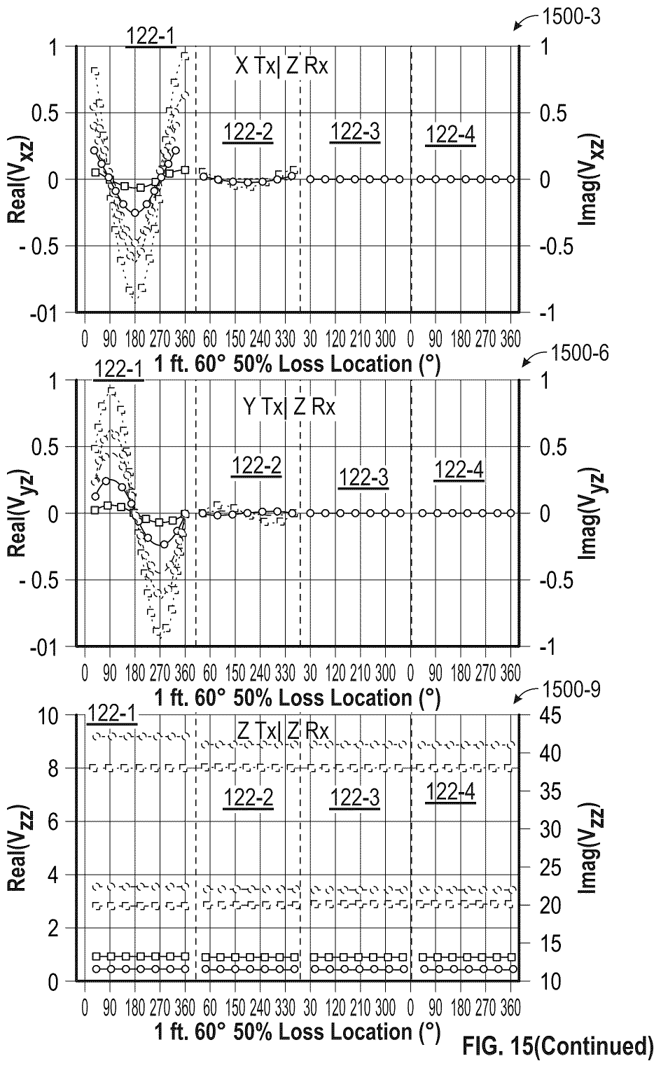

FIG. 15 depicts graphs 1500-1 to 1500-9 illustrating real and imaginary components of responses (e.g., voltage (V) magnitudes) from cross couplings of coils of a triaxial transmitter with coils of a triaxial receiver for a four-casing configuration, according to various embodiments. In particular, graphs 1500-1 to 1500-9 show the sensitivity of each of nine triaxial cross couplings for a triaxial transmitter-receiver pair (separated by an axial distance (or spacing) d₁ (e.g., d₁≈5 inches)) as a function of location of a defect (e.g., defect 148) on a “first” casing 122-1, “second” casing 122-2, “third” casing 122-3, and “fourth” casing 122-4, respectively, for multiple excitation frequencies (f₀, f₁, and f₂ where 0<f₀<f₁<f₂). For example, graph 1500-1 indicates the sensitivity for the XX cross coupling, graph 1500-2 indicates the sensitivity for the XY cross coupling, graph 1500-3 indicates the sensitivity for the XZ cross coupling, graph 1500-4 indicates the sensitivity for the YX cross coupling, graph 1500-5 indicates the sensitivity for the YY cross coupling, graph 1500-6 indicates the sensitivity for the YZ cross coupling, graph 1500-7 indicates the sensitivity for the ZX cross coupling, graph 1500-8 indicates the sensitivity for the ZY cross coupling, and graph 1500-9 indicates the sensitivity for the ZZ cross coupling.

In FIG. 15, the real components are indicated using (solid and dashed) lines with squares, and the imaginary components are indicated using (solid and dashed) lines with circles. The “first” casing 122-1 has an OD approximately equal to OD₁, the “second” casing has an OD approximately equal to OD₂, the “third” casing has an OD approximately equal to OD₃, and the “fourth” casing has an OD approximately equal to OD₄, where 0<OD₁<OD₂<OD₃<OD₄. Here, the defect is a 1 foot long, 50% loss (of casing thickness, Δ) patch with 60° aperture on the outer surface of each casing 122-1 to 122-4. Note, however, that this is merely an example and that the type and/or size of defect may be different in other scenarios.

In FIG. 15, the horizontal axis in each graph 1500-1 to 1500-9 shows the location of the defect (e.g., lossy patch) on the casings 122-1, 122-2, 122-3, and 122-4. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, the third set of 0°-360° locations corresponds to the locations of the defect on the “third” casing 122-3, and the fourth set of 0°-360° locations corresponds to the locations of the defect on the “fourth” casing 122-4.

Similar to FIGS. 10 and 12, as shown in FIG. 15, at this particular spacing (e.g., d₁) for the triaxial transmitter-receiver pair, the “first” casing defect has a greater impact on the sensitivity of the cross couplings than the “second” casing defect, the “third” casing defect, and the “fourth” casing defect. Thus, similar to FIG. 12, for four-casing configurations, for triaxial transmitter-receiver spacings less than or equal to d₁, the cross (dipole) couplings with cos(2θ) sensitivity to the location of the defect (e.g., XY and YX cross couplings indicated in graph 1500-2 and graph 1500-4, respectively) and the cross couplings with cos(θ) sensitivity to the location of the defect (e.g., XZ and YZ cross couplings indicated in graph 1500-3 and graph 1500-6, respectively) may distinctively provide the quadrant sensitivity to the defect location for the “first” casing 122-1.

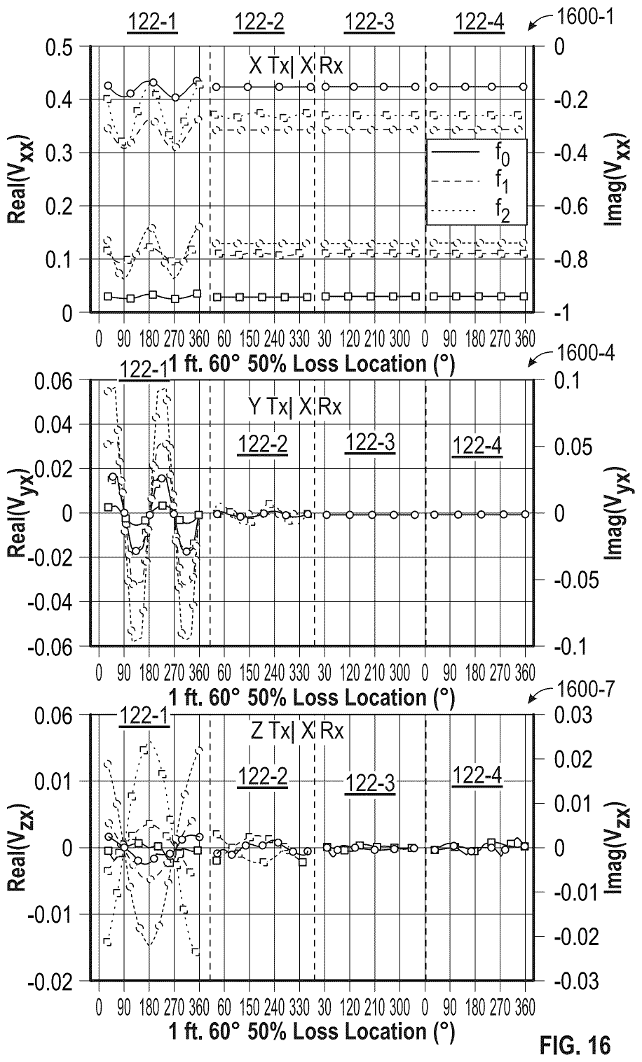

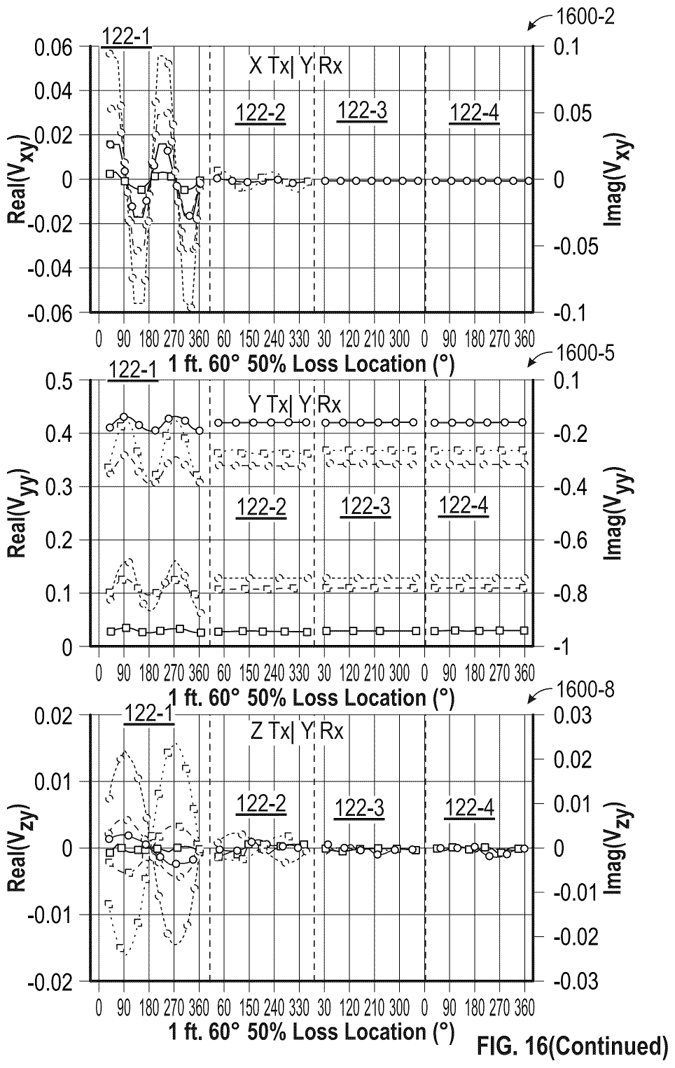

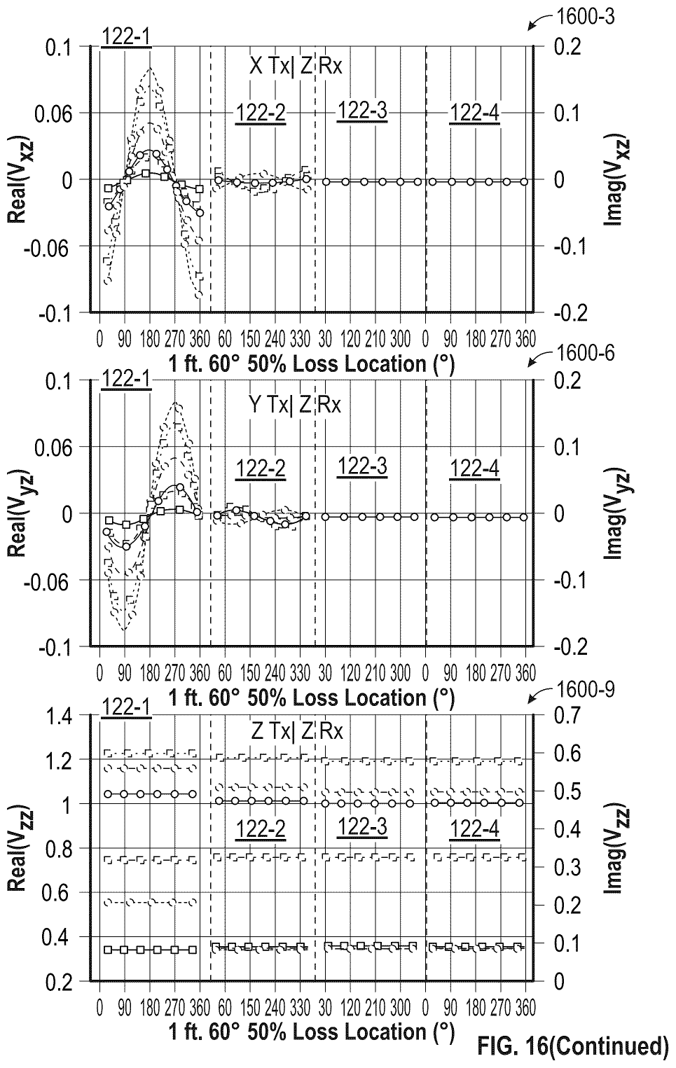

FIG. 16 depicts graphs 1600-1 to 1600-9 illustrating real and imaginary components of responses (e.g., voltage (V) magnitudes) from cross couplings of coils of a triaxial transmitter with coils of a triaxial receiver for a four-casing configuration, according to various embodiments. In particular, graphs 1600-1 to 1600-9 show the sensitivity of each of nine triaxial cross couplings for a triaxial transmitter-receiver pair (separated by an axial distance (or spacing) d₂ (e.g., d₂≈10 inches)) as a function of location of a defect (e.g., defect 148) on a “first” casing 122-1, “second” casing 122-2, “third” casing 122-3, and “fourth” casing 122-4, respectively, for multiple excitation frequencies (f₀, f₁, and f₂ where 0<f₀<f₁<f₂). For example, graph 1600-1 indicates the sensitivity for the XX cross coupling, graph 1600-2 indicates the sensitivity for the XY cross coupling, graph 1600-3 indicates the sensitivity for the XZ cross coupling, graph 1600-4 indicates the sensitivity for the YX cross coupling, graph 1600-5 indicates the sensitivity for the YY cross coupling, graph 1600-6 indicates the sensitivity for the YZ cross coupling, graph 1600-7 indicates the sensitivity for the ZX cross coupling, graph 1600-8 indicates the sensitivity for the ZY cross coupling, and graph 1600-9 indicates the sensitivity for the ZZ cross coupling.

In FIG. 16, the real components are indicated using (solid and dashed) lines with squares, and the imaginary components are indicated using (solid and dashed) lines with circles. The “first” casing 122-1 has an OD approximately equal to OD₁, the “second” casing has an OD approximately equal to OD₂, the “third” casing has an OD approximately equal to OD₃, and the “fourth” casing has an OD approximately equal to OD₄, where 0<OD₁<OD₂<OD₃<OD₄. Here, the defect is a 1 foot long, 50% loss (of casing thickness, Δ) patch with 60° aperture on the outer surface of each casing 122-1 to 122-4. Note, however, that this is merely an example and that the type and/or size of defect may be different in other scenarios.

In FIG. 16, the horizontal axis in each graph 1600-1 to 1600-9 shows the location of the defect (e.g., lossy patch) on the casings 122-1, 122-2, 122-3, and 122-4. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, the third set of 0°-360° locations corresponds to the locations of the defect on the “third” casing 122-3, and the fourth set of 0°-360° locations corresponds to the locations of the defect on the “fourth” casing 122-4.

Similar to FIGS. 11 and 13, as shown in FIG. 16, there is a stronger sensitivity to the “second” casing defect at the triaxial transmitter-receiver spacing of d₂ compared to the sensitivity to the “second” casing defect at the triaxial transmitter-receiver spacing of d₁ shown in FIG. 15. Thus, similar to FIGS. 11 and 13, in four-casing configurations, for triaxial transmitter-receiver spacings greater than or equal to d₁ and less than or equal to d₂, the cross (dipole) couplings with cos(2θ) sensitivity to the location of the defect (e.g., XY and YX cross couplings indicated in graph 1600-2 and graph 1600-4, respectively) and the cross couplings with cos(θ) sensitivity to the location of the defect (e.g., XZ and YZ cross couplings indicated in graph 1600-3 and graph 1600-6, respectively) may distinctively provide the quadrant sensitivity to the defect location for the “first” casing 122-1 and the “second” casing 122-2.

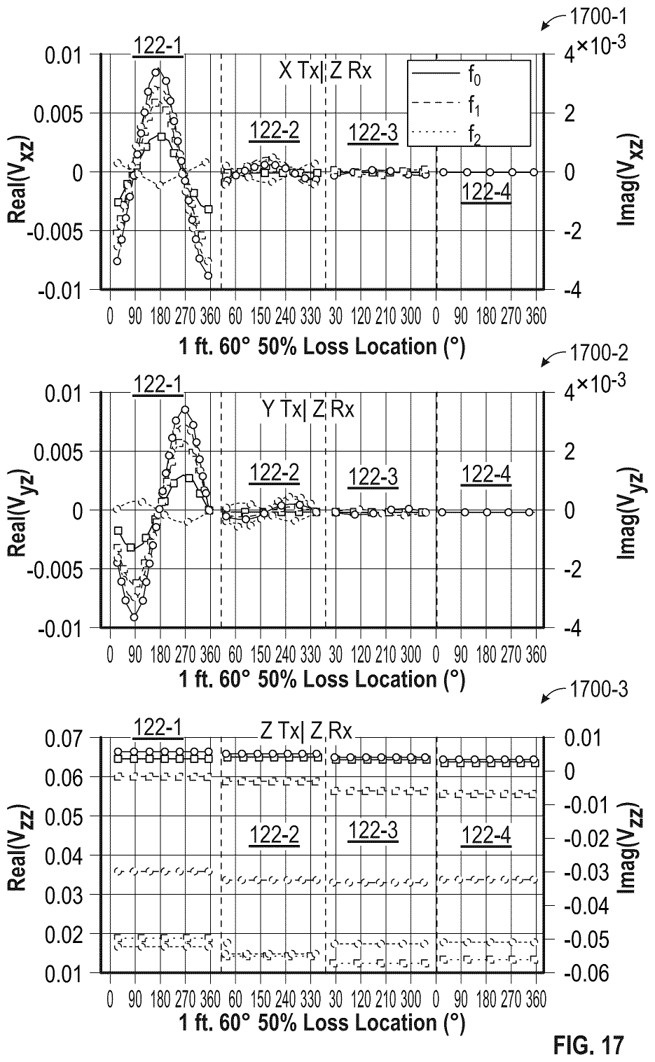

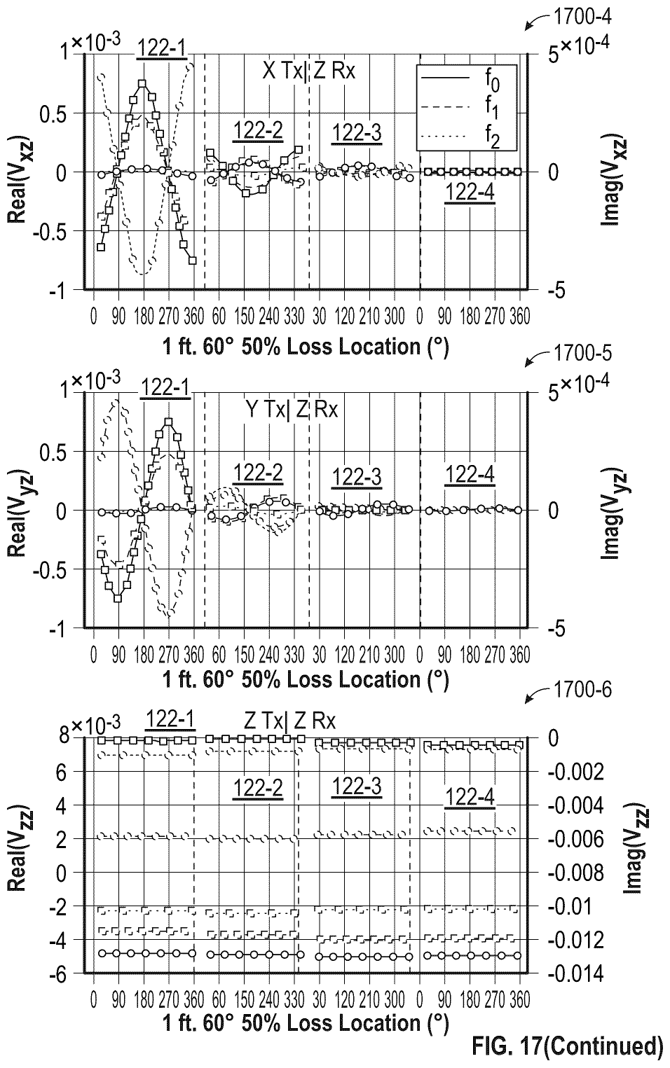

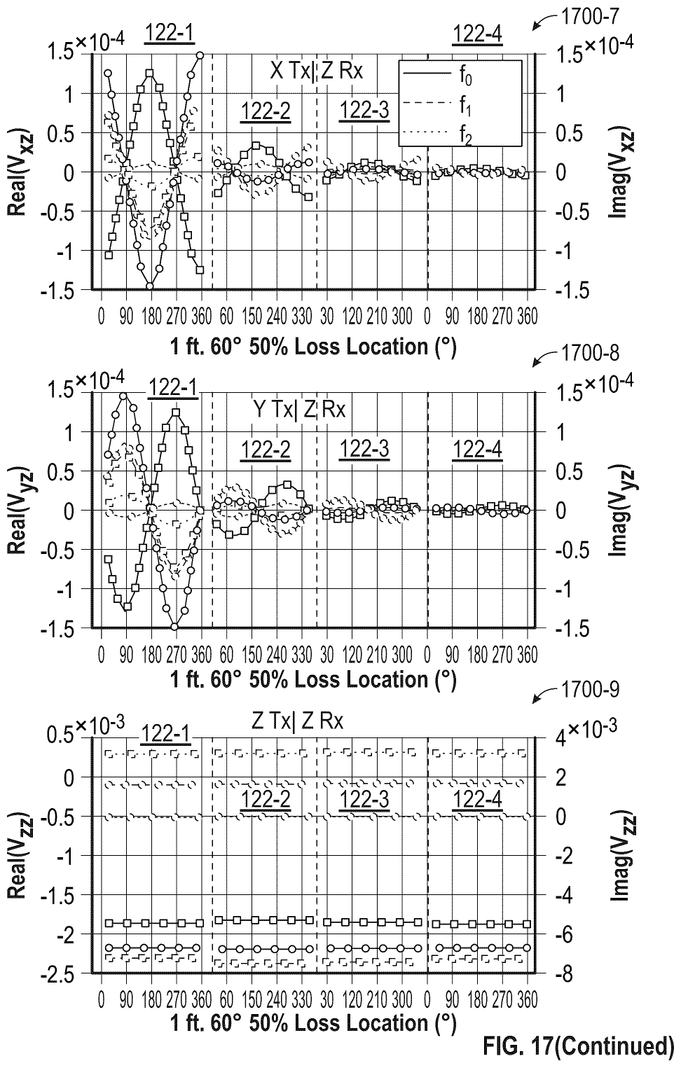

As noted with respect to FIG. 14, in some cases, the XY cross coupling and/or YX cross coupling may attenuate faster along the length of the casing 122 than other cross couplings, and, for spacings of 20 inches and more, the XZ cross coupling and/or YZ cross coupling may have the strongest responses among the nine cross couplings. By way of another example, FIG. 17 depicts graphs 1700-1 to 1700-9 illustrating real and imaginary components of responses (e.g., voltage (V) magnitudes) from certain cross couplings of coils of a triaxial transmitter with coils of a triaxial receiver for a four-casing configuration, according to various embodiments.

In particular, graphs 1700-1 to 1700-3 indicate the sensitivities for the XZ cross coupling, the YZ cross coupling, and the ZZ cross coupling, respectively, for a triaxial transmitter-receiver pair (separated by an axial distance (or spacing) d₃ (e.g., d₃≈20 inches)) as a function of location of a defect (e.g., defect 148) on a “first” casing 122-1, “second” casing 122-2, “third” casing 122-3, and “fourth” casing 122-4, respectively, for multiple excitation frequencies (f₀, f₁, and f₂ where 0<f₀<f₁<f₂).

Similarly, graphs 1700-4 to 1700-6 indicate the sensitivities for the XZ cross coupling, the YZ cross coupling, and the ZZ cross coupling, respectively, for a triaxial transmitter-receiver pair (separated by an axial distance (or spacing) d₄ (e.g., d₄≈30 inches)) as a function of location of a defect (e.g., defect 148) on a “first” casing 122-1, “second” casing 122-2, “third” casing 122-3, and “fourth” casing 122-4, respectively, for multiple excitation frequencies (f₀, f₁, and f₂ where 0<f₀<f₁<f₂).

Similarly, graphs 1700-7 to 1700-9 indicate the sensitivities for the XZ cross coupling, the YZ cross coupling, and the ZZ cross coupling, respectively, for a triaxial transmitter-receiver pair (separated by an axial distance (or spacing) d₅>d₄ (e.g., d₅≈40 inches)) as a function of location of a defect (e.g., defect 148) on a “first” casing 122-1, “second” casing 122-2, “third” casing 122-3, and “fourth” casing 122-4, respectively, for multiple excitation frequencies (f₀, f₁, and f₂ where 0<f₀<f₁<f₂).

In FIG. 17, the real components are indicated using (solid and dashed) lines with squares, and the imaginary components are indicated using (solid and dashed) lines with circles. The “first” casing 122-1 has an OD approximately equal to OD 1, the “second” casing has an OD approximately equal to OD₂, the “third” casing has an OD approximately equal to OD₃, and the “fourth” casing has an OD approximately equal to OD₄, where 0<ODI <OD₂<OD₃<OD₄. Here, the defect is a 1 foot long, 50% loss (of casing thickness, Δ) patch with 60° aperture on the outer surface of each casing 122-1 to 122-4. Note, however, that this is merely an example and that the type and/or size of defect may be different in other scenarios.

In FIG. 17, the horizontal axis in each graph 1700-1 to 1700-9 shows the location of the defect (e.g., lossy patch) on the casings 122-1, 122-2, 122-3, and 122-4. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, the third set of 0°-360° locations corresponds to the locations of the defect on the “third” casing 122-3, and the fourth set of 0°-360° locations corresponds to the locations of the defect on the “fourth” casing 122-4.

As indicated in graphs 1700-1, 1700-2, 1700-4, 1700-5, 1700-7, and 1700-8 of FIG. 17, there is stronger sensitivity to the “second,” “third,” and “fourth” casing defects at farther triaxial transmitter-receiver spacings (e.g., d₄ and/or d₅), compared to the sensitivity to the “second,” “third,” and “fourth” casing defects at triaxial transmitter-receiver spacings of shorter spacings (e.g., d₁ and d₂ shown in FIGS. 15 and 16, respectively). Accordingly, for four-casing configurations, at triaxial transmitter-receiver spacings of at least d₄, the sensitivities to the “second,” “third,” and “fourth” casing defects (e.g., as indicated in graphs 1700-1, 1700-2, 1700-4, 1700-5, 1700-7, and 1700-8) may provide left-right or lateral sensitivity to the location of an azimuthally located casing defect in the “second,” “third,” and/or “fourth” casings 122. That is, while triaxial transmitter-receiver spacings of d₁ and d₂ can provide quadrant sensitivity to defect locations on the inner “first” and “second” casings 122-1 to 122-2, the variation of lateral sensitivity in XZ and/or YZ cross couplings can be used to discriminate azimuthal defect locations in the “third” and “fourth” casings 122-3 to 122-4.

As noted, in certain embodiments, for “third” and “fourth” outer casings 122, the quadrant-based location of a defect on the “third” and “fourth” casings 122 may be determined based at least in part on (i) the out-of-phase XZ cross coupling and/or (ii) the out-of-phase YZ cross coupling. For example, the positioning of X and Y directed saddle coils may provide a 90° phase shift between the (i) XZ cross coupling and (ii) YZ cross coupling. Additionally, for some frequencies, the real and imaginary components of the XZ cross coupling and the YZ cross coupling may be out-of-phase by approximately 180° (e.g., the real and imaginary components for the XZ cross coupling may have an opposite sign than the real and imaginary components for the YZ cross coupling). These 180° out-of-phase XZ and YZ cross coupling components together with the 90° phase difference between the XZ and YZ cross coupling components may provide quadrant sensitivity to the location of the azimuthal loss on the surface of any outer casing 122.

In certain embodiments, this sign-based quadrant sensitivity from out-of-phase XZ and YZ cross coupling components may be used for “third” and “fourth” casings 122-3 and 122-4 using triaxial transmitter-receiver spacings at d₃, d₄, and/or d₅. For example, as noted above, at such farther spacings, using the cross coupling information of the XZ and/or YZ cross couplings, alone, may provide lateral sensitivity, but not quadrant sensitivity, to defect locations on “third” and “fourth” casings 122-3 and 122-4.

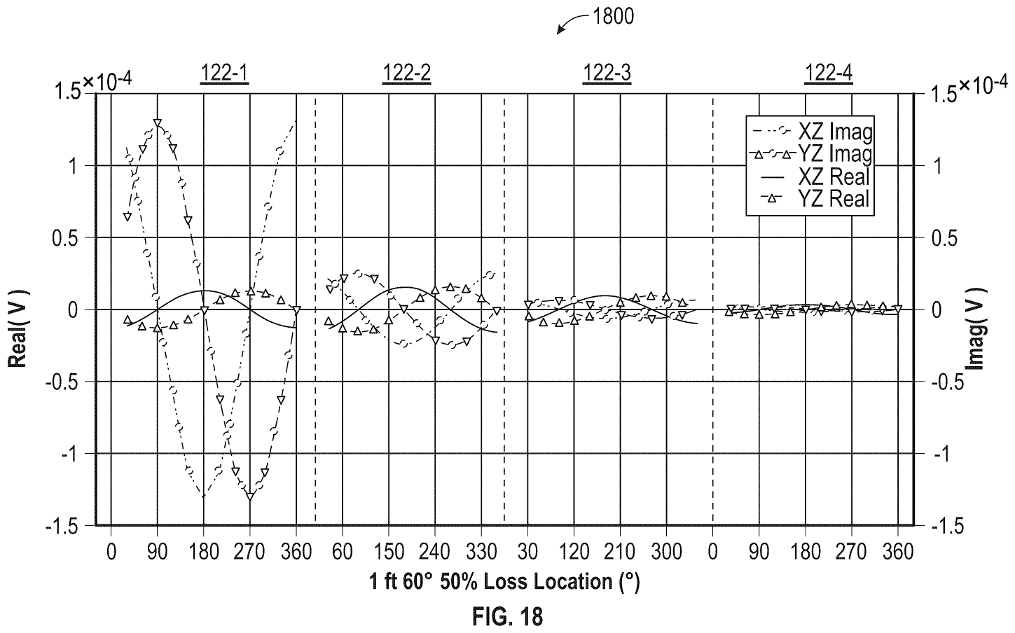

By way of example, FIG. 18 depicts a graph 1800 illustrating out-of-phase real and imaginary components of responses from certain cross couplings of coils of a triaxial transmitter with coils of a triaxial receiver for a four-casing configuration, according to various embodiments. In particular, graph 1800 indicates the 180° out-of-phase real and imaginary components of the (i) XZ cross coupling and (ii) YZ cross coupling for a triaxial transmitter-receiver pair (separated by an axial distance (or spacing) d₅ (e.g., d₅≈40 inches)) as a function of location of a defect (e.g., defect 148) on a “first” casing 122-1, “second” casing 122-2, “third” casing 122-3, and “fourth” casing 122-4, respectively.

In FIG. 18, the “first” casing 122-1 has an OD approximately equal to OD₁, the “second” casing has an OD approximately equal to OD₂, the “third” casing has an OD approximately equal to OD₃, and the “fourth” casing has an OD approximately equal to OD₄, where 0<OD₁<OD₂<OD₃<OD₄. Here, the defect is a 1 foot long, 50% loss (of casing thickness, Δ) patch with 60° aperture on the outer surface of each casing 122-1 to 122-4. Note, however, that this is merely an example and that the type and/or size of defect may be different in other scenarios.

In FIG. 18, the horizontal axis in graph 1800 shows the location of the defect (e.g., lossy patch) on the casings 122-1, 122-2, 122-3, and 122-4. The location of the defect is changed from 0°-360° in steps of 30° individually along each casing 122 while keeping nominal thickness for other casings. The first set of 0°-360° locations corresponds to the locations of the defect on the “first” casing 122-1, the second set of 0°-360° locations corresponds to the locations of the defect on the “second” casing 122-2, the third set of 0°-360° locations corresponds to the locations of the defect on the “third” casing 122-3, and the fourth set of 0°-360° locations corresponds to the locations of the defect on the “fourth” casing 122-4.

As shown in FIG. 18, the out-of-phase components together with the 90° phase difference between the XZ cross coupling and the YZ cross coupling provide quadrant sensitivity to the location of the azimuthal loss on the surface of the “first,” “second,” “third,” and “fourth” casings 122-1 to 122-4.

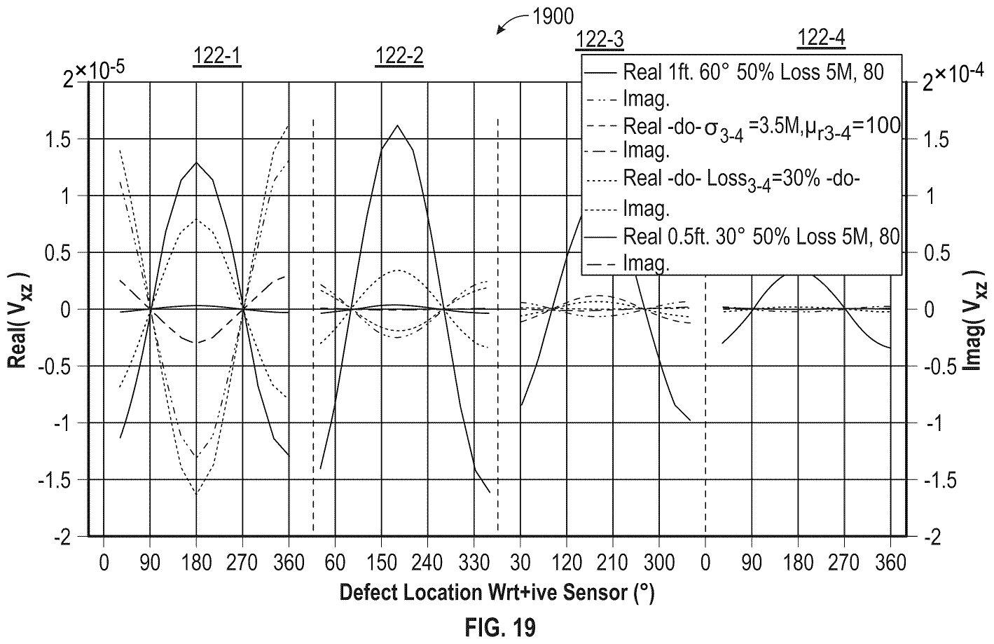

By way of another example, FIG. 19 depicts a graph 1900 illustrating an example of consistent phase difference between real and imaginary components of certain cross couplings of coils of a triaxial transmitter with coils of a triaxial receiver for a four-casing configuration, according to various embodiments. In particular, graph 1900 indicates a consistent 180° phase difference between real and imaginary components of the XZ cross coupling for a triaxial transmitter-receiver pair (separated by an axial distance (or spacing) d₅ (e.g., d₅≈40 inches)) as a function of location of a defect (e.g., defect 148) on a “first” casing 122-1, “second” casing 122-2, “third” casing 122-3, and “fourth” casing 122-4, respectively, for a frequency of 3 Hz. As indicated in graph 1900, the 180° out-of-phase splitting of 3 Hz real and imaginary XZ cross coupling is not an isolated behavior, but is generally present for different “third” and “fourth” casing materials and extent of casing losses. In some cases, even when all the casing losses are halved in length and radial extent, there may be a consistent 180 out-of-phase splitting in these components. Note, however that this consistent phase difference is generally a frequency dependent phenomenon (e.g., the consistent phase difference may occur at 3 Hz, but may not occur at 1 Hz or 5 Hz).

Accordingly, using the techniques described herein, the presence of a defect (e.g., metal loss or gain) in each of one or more casings of a multi-casing configuration can be identified and localized within a geometrical quadrant, based on multi-frequency, non-collocated, induction measurements obtained via an EM inspection tool 160.

For example, such induction measurements may provide: (i) quadrant sensitivity of short (e.g., up to 5 inches) spacing coils' cross couplings for the “first” casing 122; (ii) quadrant sensitivity of short (e.g., approximately between 5-10 inches) spacing coil's cross-couplings for the “first” and “second” casings 122; (iii) lateral sensitivity of longer (e.g., at least 20 inches) spacing coils' XZ cross coupling and YZ cross coupling for the “third” and “fourth” casings 122; (iv) sign-based XZ cross coupling and/or YZ cross coupling quadrant identification for outer “third” and “fourth” casings using longer spacing coils; and (v) any combination thereof. Advantageously, the quadrant and deep lateral sensitivities from the multi-frequency and multi-spacing measurements can be processed to provide a directional detection of localized corrosion spots on the inner or outer surface of the casing compared to existing axial coil-based sensors.

### Example Operations

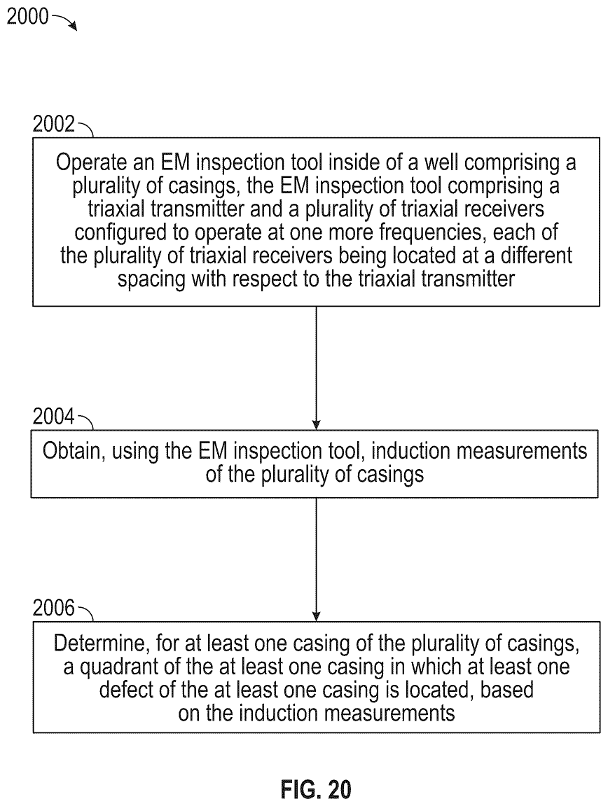

FIG. 20 is a flow diagram depicting an example operations 2000 for determining quadrant-based locations of casings defects based on multi-frequency, non-collocated, induction measurements. The operations 2000 may be performed, for example, by an evaluation component (e.g., evaluation component 922). The operations 2000 may be implemented as software components that are executed and run on one or more processors (e.g., the processor 910 of data processing system 138).

The operations 2000 may involve, at block 2002, operating (or controlling) an EM inspection tool (e.g., EM inspection tool 160) in a well (e.g., wellbore 116) including a plurality of casings (e.g., casings 122). The EM inspection tool includes a triaxial transmitter (e.g., triaxial transmitter 260 of FIG. 2 or triaxial transmitter 400 of FIGS. 4 and 7) and a plurality of non-collocated triaxial receivers (e.g., triaxial receivers 262, 264, 266, 268, 269 of FIG. 2, triaxial receivers 500 of FIGS. 5 and 7, or any combination thereof) configured to operate at one or more frequencies. Each of the plurality of non-collocated triaxial receivers is located at a different spacing with respect to the triaxial transmitter.

The triaxial transmitter is configured to emit a respective one or more primary time-varying magnetic field signals in the plurality of casings in a radial direction (e.g., X direction), a tangential direction (e.g., Y direction), and an axial direction (e.g., Z direction) with respect to the plurality of casings. Each of the respective one or more primary time-varying magnetic field signals may induce a corresponding one or more secondary time-varying magnetic field signals in the plurality of casings in the radial direction, the tangential direction, and the axial direction, and the one or more secondary time-varying magnetic field signals may be detected by one or more of the plurality of triaxial receivers.

The operations 2000 may also involve, at block 2004, obtaining, using the EM inspection tool, induction measurements of the plurality of casings.

The operations 2000 may also involve, at block 2006, determining for at least one casing of the plurality of casings, a quadrant (e.g., quadrant 810, quadrant 820, quadrant 830, or quadrant 840) of the at least one casing in which at least one defect (e.g., defect 148) of the at least one casing is located, based on the induction measurements.

In certain embodiments, the triaxial transmitter includes (i) a first coil radially aligned with respect to the EM inspection tool and configured to emit the one or more primary time-varying magnetic field signals in the radial direction (e.g., X Tx coil 410 of FIG. 4 or saddle coil 620-1 of FIG. 7), (ii) a second coil tangentially aligned with respect to the EM inspection tool and configured to emit the one or more primary time-varying magnetic field signals in the tangential direction (e.g., Y Tx coil 420 of FIG. 4 or saddle coil 630-1 of FIG. 7), and (iii) a third coil axially aligned with respect to the EM inspection tool and configured to emit the one or more primary time-varying magnetic field signals in the axial direction (e.g., Z Tx coil 430). Additionally, in certain embodiments, each of the plurality of triaxial receivers includes (i) a first coil radially aligned with respect to the EM inspection tool (e.g., X Rx coil 510 of FIG. 5 or saddle coil 620-2 of FIG. 7), (ii) a second coil tangentially aligned with respect to the EM inspection tool (e.g., Y Rx coil 520 of FIG. 5 or saddle coil 630-2 of FIG. 7), and (iii) a third coil axially aligned with respect to the EM inspection tool (e.g., Z Tx coil 530).

In certain embodiments, for each triaxial receiver of the plurality of triaxial receivers, the induction measurements include (i) a first set of magnitude measurements associated with a cross coupling of the first coil of the triaxial transmitter with the first coil of the triaxial receiver (e.g., cross coupling of X Tx coil with X Rx coil), (ii) a second set of magnitude measurements associated with a cross coupling of the first coil of the triaxial transmitter with the second coil of the triaxial receiver (e.g., cross coupling of X Tx coil with Y Rx coil), (iii) a third set of magnitude measurements associated with a cross coupling of the first coil of the triaxial transmitter with the third coil of the triaxial receiver (e.g., cross coupling of X Tx coil with Z Rx coil), (iv) a fourth set of magnitude measurements associated with a cross coupling of the second coil of the triaxial transmitter with the first coil of the triaxial receiver (e.g., cross coupling of Y Tx coil with X Rx coil), (v) a fifth set of magnitude measurements associated with a cross coupling of the second coil of the triaxial transmitter with the second coil of the triaxial receiver (e.g., cross coupling of Y Tx coil with Y Rx coil), (vi) a sixth set of magnitude measurements associated with a cross coupling of the second coil of the triaxial transmitter with the third coil of the triaxial receiver (e.g., cross coupling of Y Tx coil with Z Rx coil), (vii) a seventh set of magnitude measurements associated with a cross coupling of the third coil of the triaxial transmitter with the first coil of the triaxial receiver (e.g., cross coupling of Z Tx coil with X Rx coil), (viii) an eight set of magnitude measurements associated with a cross coupling of the third coil of the triaxial transmitter with the second coil of the triaxial receiver (e.g., cross coupling of Z Tx coil with Y Rx coil), (ix) a ninth set of magnitude measurements associated with a cross coupling of the third coil of the triaxial transmitter with the third coil of the triaxial receiver (e.g., cross coupling of Z Tx coil with Z Rx coil), or (x) any combination thereof. In certain embodiments, the induction measurements provide quadrant sensitivity to one or more defects within at least one of a first casing (e.g., casing 122-1), a second casing (e.g., casing 122-2), a third casing (e.g., casing 122-3), or a fourth casing (e.g., casing 122-4) of the plurality of casings.

In certain embodiments, determining the quadrant of the least one casing in which the at least one defect is located (at block 2006) includes determining the quadrant of the first casing (e.g., casing 122-1) in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver (e.g., cross coupling of X Tx coil with Y Rx coil) or (ii) the respective fourth set of magnitude measurements associated with the cross coupling of the second coil of the triaxial transmitter with the first coil of the triaxial receiver (e.g., cross coupling of Y Tx coil with X Rx coil). In certain embodiments, the spacing of the at least one triaxial receiver with respect to the triaxial transmitter is less than 5 inches. In certain embodiments, the first casing is an innermost casing of the plurality of casings.

In certain embodiments, determining the quadrant of the least one casing in which the at least one defect is located (at block 2006) includes determining the quadrant of the second casing (e.g., casing 122-2) in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver (e.g., cross coupling of X Tx coil with Y Rx coil) or (ii) the respective fourth set of magnitude measurements associated with the cross coupling of the second coil of the triaxial transmitter with the first coil of the triaxial receiver (e.g., cross coupling of Y Tx coil with X Rx coil). In certain embodiments, the spacing of the at least one triaxial receiver with respect to the triaxial transmitter is greater than or equal to 5 inches and less than 10 inches. In certain embodiments, the first casing is nested within the second casing.

In certain embodiments, the operations 2000 further include determining, for the third casing (e.g., casing 122-3), a lateral portion (e.g., 180° portion) of the third casing in which the at least one defect is located based on, for at least one triaxial receiver of the plurality of triaxial receivers, at least one of (i) the respective third set of magnitude measurements associated with the cross coupling of the first coil of the triaxial transmitter with the third coil of the triaxial receiver (e.g., cross coupling of X Tx coil with the Z Rx coil) or (ii) the respective sixth set of magnitude measurements associated with the cross coupling of the second coil of the triaxial transmitter with the third coil of the triaxial receiver (e.g., cross coupling of Y Tx coil with the Z Rx coil). Additionally, in certain embodiments, determining the quadrant of the least one casing in which the at least one defect is located (in block 2006) includes determining the quadrant of the third casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver. In certain embodiments, a spacing of the at least one triaxial receiver with respect to the triaxial transmitter is greater than or equal to 20 inches and less than 30 inches. In certain embodiments, the first casing and the second casing are nested within the third casing.

In certain embodiments, the operations 2000 further include determining, for the fourth casing (e.g., casing 122-4), a lateral portion (e.g., 180° portion) of the fourth casing in which the at least one defect is located based on, for at least one triaxial receiver of the plurality of triaxial receivers, at least one of (i) the respective third set of magnitude measurements associated with the cross coupling of the first coil of the triaxial transmitter with the third coil of the triaxial receiver (e.g., cross coupling of X Tx coil with the Z Rx coil) or (ii) the respective sixth set of magnitude measurements associated with the cross coupling of the second coil of the triaxial transmitter with the third coil of the triaxial receiver (e.g., cross coupling of Y Tx coil with the Z Rx coil). Additionally, in certain embodiments, determining the quadrant of the least one casing in which the at least one defect is located (in block 2006) includes determining the quadrant of the fourth casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver. In certain embodiments, a spacing of the at least one triaxial receiver with respect to the triaxial transmitter is greater than or equal to 30 inches and less than or equal to 40 inches. In certain embodiments, the first casing, the second casing, and the third casing are nested within the fourth casing.

In certain embodiments, each of the first coil of the triaxial transmitter, the second coil of the triaxial transmitter, the first coil of each of the plurality of triaxial receivers, and the second coil of each of the plurality of triaxial receivers is a different saddle coil.

### Example Clauses

Implementation examples are described in the following numbered clauses:
Clause 1: A method comprising: operating an electromagnetic (EM) inspection tool inside of a well comprising a plurality of casings, the EM inspection tool comprising a triaxial transmitter and a plurality of triaxial receivers configured to operate at one or more frequencies, each of the plurality of triaxial receivers being located at a different spacing with respect to the triaxial transmitter, the triaxial transmitter being configured to emit a respective one or more primary time-varying magnetic field signals in the plurality of casings in a radial direction, a tangential direction, and an axial direction with respect to the plurality of casings, each of the respective one or more primary time-varying magnetic field signals inducing a corresponding one or more secondary time-varying magnetic field signals in the plurality of casings in the radial direction, the tangential direction, and the axial direction, and the one or more secondary time-varying magnetic field signals being detected by one or more of the plurality of triaxial receivers; obtaining, using the EM inspection tool, induction measurements of the plurality of casings; and determining, for at least one casing of the plurality of casings, a quadrant of the least one casing in which at least one defect of the at least one casing is located, based on the induction measurements.
Clause 2: The method of Clause 1, wherein: the triaxial transmitter comprises (i) a first coil radially aligned with respect to the EM inspection tool and configured to emit the one or more primary time-varying magnetic field signals in the radial direction, (ii) a second coil tangentially aligned with respect to the EM inspection tool and configured to emit the one or more primary time-varying magnetic field signals in the tangential direction, and (iii) a third coil axially aligned with respect to the EM inspection tool and configured to emit the one or more primary time-varying magnetic field signals in the axial direction; and each of the plurality of triaxial receivers comprises (i) a first coil radially aligned with respect to the EM inspection tool, (ii) a second coil tangentially aligned with respect to the EM inspection tool, and (iii) a third coil axially aligned with respect to the EM inspection tool.
Clause 3: The method of Clause 2, wherein: for each triaxial receiver of the plurality of triaxial receivers, the induction measurements comprise (i) a first set of magnitude measurements associated with a cross coupling of the first coil of the triaxial transmitter with the first coil of the triaxial receiver, (ii) a second set of magnitude measurements associated with a cross coupling of the first coil of the triaxial transmitter with the second coil of the triaxial receiver, (iii) a third set of magnitude measurements associated with a cross coupling of the first coil of the triaxial transmitter with the third coil of the triaxial receiver, (iv) a fourth set of magnitude measurements associated with a cross coupling of the second coil of the triaxial transmitter with the first coil of the triaxial receiver, (v) a fifth set of magnitude measurements associated with a cross coupling of the second coil of the triaxial transmitter with the second coil of the triaxial receiver, (vi) a sixth set of magnitude measurements associated with a cross coupling of the second coil of the triaxial transmitter with the third coil of the triaxial receiver, (vii) a seventh set of magnitude measurements associated with a cross coupling of the third coil of the triaxial transmitter with the first coil of the triaxial receiver, (viii) an eight set of magnitude measurements associated with a cross coupling of the third coil of the triaxial transmitter with the second coil of the triaxial receiver, (ix) a ninth set of magnitude measurements associated with a cross coupling of the third coil of the triaxial transmitter with the third coil of the triaxial receiver, or (x) any combination thereof; and the induction measurements provide quadrant sensitivity to one or more defects within at least one of a first casing, a second casing, a third casing, or a fourth casing of the plurality of casings.
Clause 4: The method of Clause 3, wherein determining the quadrant of the least one casing in which the at least one defect is located comprises determining the quadrant of the first casing in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver or (ii) the respective fourth set of magnitude measurements associated with the cross coupling of the second coil of the triaxial transmitter with the first coil of the triaxial receiver.
Clause 5: The method of Clause 4, wherein a spacing of the at least one triaxial receiver with respect to the triaxial transmitter is less than 5 inches.
Clause 6: The method according to any of Clauses 4-5, wherein the first casing is an innermost casing of the plurality of casings.
Clause 7: The method according to any of Clauses 3-6, wherein determining the quadrant of the least one casing in which the at least one defect is located comprises determining the quadrant of the second casing in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver or (ii) the respective fourth set of magnitude measurements associated with the cross coupling of the second coil of the triaxial transmitter with the first coil of the triaxial receiver.
Clause 8: The method of Clause 7, wherein a spacing of the at least one triaxial receiver with respect to the triaxial transmitter is greater than or equal to 5 inches and less than 10 inches.
Clause 9: The method according to any of Clauses 7-8, wherein the first casing is nested within the second casing.
Clause 10: The method according to any of Clauses 3-9, further comprising determining, for the third casing, a lateral portion of the third casing in which at least one defect of the third casing is located, based on, for at least one triaxial receiver of the plurality of triaxial receivers, at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.
Clause 11: The method of Clause 10, wherein determining the quadrant of the least one casing in which the at least one defect is located comprises determining the quadrant of the third casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.
Clause 12: The method according to any of Clauses 10-11, wherein a spacing of the at least one triaxial receiver with respect to the triaxial transmitter is greater than or equal to 20 inches and less than 30 inches.
Clause 13: The method according to any of Clauses 10-12, wherein the first casing and the second casing are nested within the third casing.
Clause 14: The method according to any of Clauses 3-13, further comprising determining, for the fourth casing, a lateral portion of the fourth casing in which at least one defect of the fourth casing is located, based on, for at least one triaxial receiver of the plurality of triaxial receivers, at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.
Clause 15: The method of Clause 14, wherein determining the quadrant of the least one casing in which the at least one defect is located comprises determining the quadrant of the fourth casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.
Clause 16: The method according to any of Clauses 14-15, wherein a spacing of the at least one triaxial receiver with respect to the triaxial transmitter is greater than or equal to 30 inches and less than or equal to 40 inches.
Clause 17: The method according to any of Clauses 14-16, wherein each of the first casing, the second casing, and the third casing is nested within the fourth casing.
Clause 18: The method according to any of Clauses 2-17, wherein each of the first coil of the triaxial transmitter, the second coil of the triaxial transmitter, the first coil of each of the plurality of triaxial receivers, and the second coil of each of the plurality of triaxial receivers is a different saddle coil.
Clause 19: A system comprising: a plurality of casings disposed in a well; an electromagnetic (EM) inspection tool disposed in the plurality of casings, wherein the EM inspection tool comprises a triaxial transmitter and a plurality of triaxial receivers configured to operate at one or more frequencies, each of the plurality of triaxial receivers being located at a different spacing with respect to the triaxial transmitter, the triaxial transmitter being configured to emit a respective one or more primary time-varying magnetic field signals in the plurality of casings in a radial direction, a tangential direction, and an axial direction with respect to the plurality of casings, each of the respective one or more primary time-varying magnetic field signals inducing a corresponding one or more secondary time-varying magnetic field signals in the plurality of casings in the radial direction, the tangential direction, and the axial direction, and the one or more secondary time-varying magnetic field signals being detected by one or more of the plurality of triaxial receivers; a control system communicatively coupled to the EM inspection tool, the control system comprising: one or more memories collectively storing instructions; and one or more processors coupled to the one or more memories, the one or more processors being collectively configured to execute the instructions to cause the control system to perform an operation comprising: obtaining, using the EM inspection tool, induction measurements of the plurality of casings; and determining, for at least one casing of the plurality of casings, a quadrant of the at least one casing in which at least one defect of the at least one casing is located, based on the induction measurements.
Clause 20: The system of Clause 19, wherein: the triaxial transmitter comprises (i) a first coil radially aligned with respect to the EM inspection tool and configured to emit the one or more primary time-varying magnetic field signals in the radial direction, (ii) a second coil tangentially aligned with respect to the EM inspection tool and configured to emit the one or more primary time-varying magnetic field signals in the tangential direction, and (iii) a third coil axially aligned with respect to the EM inspection tool and configured to emit the one or more primary time-varying magnetic field signals in the axial direction; and the triaxial receiver comprises (i) a first coil radially aligned with respect to the EM inspection tool, (ii) a second coil tangentially aligned with respect to the EM inspection tool, and (iii) a third coil axially aligned with respect to the EM inspection tool.
Clause 21: A non-transitory computer-readable medium comprising computer-executable instructions that, when executed by one or more processors of a computing system, cause the computing system to perform a method in accordance with any of Clauses 1-18.
Clause 22: A computing system comprising: one or more memories collectively storing executable instructions; and one or more processors coupled to the one or more memories, the one or more processors being collectively configured to execute the executable instructions and cause the computing system to perform a method in accordance with any of Clauses 1-18.
Clause 23: An apparatus comprising means for performing a method in accordance with any of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method comprising:
operating an electromagnetic (EM) inspection tool inside of a well comprising a plurality of casings, the EM inspection tool comprising a triaxial transmitter and a plurality of triaxial receivers configured to operate at one or more frequencies, each of the plurality of triaxial receivers being located at a different spacing with respect to the triaxial transmitter, the triaxial transmitter being configured to emit a respective one or more primary time-varying magnetic field signals in the plurality of casings in a radial direction, a tangential direction, and an axial direction with respect to the plurality of casings, each of the respective one or more primary time-varying magnetic field signals inducing a corresponding one or more secondary time-varying magnetic field signals in the plurality of casings in the radial direction, the tangential direction, and the axial direction, and the one or more secondary time-varying magnetic field signals being detected by one or more of the plurality of triaxial receivers;
obtaining, using the EM inspection tool, induction measurements of the plurality of casings; and
determining, for at least one casing of the plurality of casings, a quadrant of the least one casing in which at least one defect of the at least one casing is located, based on the induction measurements.

2. The method of claim 1, wherein:
the triaxial transmitter comprises (i) a first coil radially aligned with respect to the EM inspection tool and configured to emit the one or more primary time-varying magnetic field signals in the radial direction, (ii) a second coil tangentially aligned with respect to the EM inspection tool and configured to emit the one or more primary time-varying magnetic field signals in the tangential direction, and (iii) a third coil axially aligned with respect to the EM inspection tool and configured to emit the one or more primary time-varying magnetic field signals in the axial direction; and
each of the plurality of triaxial receivers comprises (i) a first coil radially aligned with respect to the EM inspection tool, (ii) a second coil tangentially aligned with respect to the EM inspection tool, and (iii) a third coil axially aligned with respect to the EM inspection tool.

3. The method of claim 2, wherein:
for each triaxial receiver of the plurality of triaxial receivers, the induction measurements comprise (i) a first set of magnitude measurements associated with a cross coupling of the first coil of the triaxial transmitter with the first coil of the triaxial receiver, (ii) a second set of magnitude measurements associated with a cross coupling of the first coil of the triaxial transmitter with the second coil of the triaxial receiver, (iii) a third set of magnitude measurements associated with a cross coupling of the first coil of the triaxial transmitter with the third coil of the triaxial receiver, (iv) a fourth set of magnitude measurements associated with a cross coupling of the second coil of the triaxial transmitter with the first coil of the triaxial receiver, (v) a fifth set of magnitude measurements associated with a cross coupling of the second coil of the triaxial transmitter with the second coil of the triaxial receiver, (vi) a sixth set of magnitude measurements associated with a cross coupling of the second coil of the triaxial transmitter with the third coil of the triaxial receiver, (vii) a seventh set of magnitude measurements associated with a cross coupling of the third coil of the triaxial transmitter with the first coil of the triaxial receiver, (viii) an eight set of magnitude measurements associated with a cross coupling of the third coil of the triaxial transmitter with the second coil of the triaxial receiver, (ix) a ninth set of magnitude measurements associated with a cross coupling of the third coil of the triaxial transmitter with the third coil of the triaxial receiver, or (x) any combination thereof; and
the induction measurements provide quadrant sensitivity to one or more defects within at least one of a first casing, a second casing, a third casing, or a fourth casing of the plurality of casings.

4. The method of claim 3, wherein determining the quadrant of the least one casing in which the at least one defect is located comprises determining the quadrant of the first casing in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver or (ii) the respective fourth set of magnitude measurements associated with the cross coupling of the second coil of the triaxial transmitter with the first coil of the triaxial receiver.

5. The method of claim 4, wherein a spacing of the at least one triaxial receiver with respect to the triaxial transmitter is less than 5 inches.

6. The method of claim 4, wherein the first casing is an innermost casing of the plurality of casings.

7. The method of claim 3, wherein determining the quadrant of the least one casing in which the at least one defect is located comprises determining the quadrant of the second casing in which the at least one defect is located based on, for at least one triaxial receiver of the plurality of triaxial receivers, at least one of (i) the respective second set of magnitude measurements associated with the cross coupling of the first coil of the triaxial transmitter with the second coil of the triaxial receiver or (ii) the respective fourth set of magnitude measurements associated with the cross coupling of the second coil of the triaxial transmitter with the first coil of the triaxial receiver.

8. The method of claim 7, wherein a spacing of the at least one triaxial receiver with respect to the triaxial transmitter is greater than or equal to 5 inches and less than 10 inches.

9. The method of claim 7, wherein the first casing is nested within the second casing.

10. The method of claim 3, further comprising determining, for the third casing, a lateral portion of the third casing in which at least one defect of the third casing is located, based on, for at least one triaxial receiver of the plurality of triaxial receivers, at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.

11. The method of claim 10, wherein determining the quadrant of the least one casing in which the at least one defect is located comprises determining the quadrant of the third casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.

12. The method of claim 11, wherein a spacing of the at least one triaxial receiver with respect to the triaxial transmitter is greater than or equal to 20 inches and less than 30 inches.

13. The method of claim 11, wherein the first casing and the second casing are nested within the third casing.

14. The method of claim 3, further comprising determining, for the fourth casing, a lateral portion of the fourth casing in which at least one defect of the fourth casing is located, based on, for at least one triaxial receiver of the plurality of triaxial receivers, at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.

15. The method of claim 14, wherein determining the quadrant of the least one casing in which the at least one defect is located comprises determining the quadrant of the fourth casing in which the at least one defect is located based on phase information associated with at least one of (i) the respective third set of magnitude measurements associated with the cross coupling of the first coil of the triaxial transmitter with the third coil of the triaxial receiver or (ii) the respective sixth set of magnitude measurements associated with the cross coupling of the second coil of the triaxial transmitter with the third coil of the triaxial receiver.

16. The method of claim 15, wherein a spacing of the at least one triaxial receiver with respect to the triaxial transmitter is greater than or equal to 30 inches and less than or equal to 40 inches.

17. The method of claim 15, wherein each of the first casing, the second casing, and the third casing is nested within the fourth casing.

18. The method of claim 2, wherein each of the first coil of the triaxial transmitter, the second coil of the triaxial transmitter, the first coil of each of the plurality of triaxial receivers, and the second coil of each of the plurality of triaxial receivers is a different saddle coil.

19. A system comprising:
a plurality of casings disposed in a well;
an electromagnetic (EM) inspection tool disposed in the plurality of casings, wherein the EM inspection tool comprises a triaxial transmitter and a plurality of triaxial receivers configured to operate at one or more frequencies, each of the plurality of triaxial receivers being located at a different spacing with respect to the triaxial transmitter, the triaxial transmitter being configured to emit a respective one or more primary time-varying magnetic field signals in the plurality of casings in a radial direction, a tangential direction, and an axial direction with respect to the plurality of casings, each of the respective one or more primary time-varying magnetic field signals inducing a corresponding one or more secondary time-varying magnetic field signals in the plurality of casings in the radial direction, the tangential direction, and the axial direction, and the one or more secondary time-varying magnetic field signals being detected by one or more of the plurality of triaxial receivers;
a control system communicatively coupled to the EM inspection tool, the control system comprising:
one or more memories collectively storing instructions; and
one or more processors coupled to the one or more memories, the one or more processors being collectively configured to execute the instructions to cause the control system to perform an operation comprising:
obtaining, using the EM inspection tool, induction measurements of the plurality of casings; and
determining, for at least one casing of the plurality of casings, a quadrant of the at least one casing in which at least one defect of the at least one casing is located, based on the induction measurements.

20. A non-transitory computer-readable medium comprising computer-executable instructions that, when executed by one or more processors of a computing system, cause the computing system to perform an operation comprising:
operating an electromagnetic (EM) inspection tool inside of a well comprising a plurality of casings, the EM inspection tool comprising a triaxial transmitter and a plurality of triaxial receivers configured to operate at one or more frequencies, each of the plurality of triaxial receivers being located at a different spacing with respect to the triaxial transmitter, the triaxial transmitter being configured to emit a respective one or more primary time-varying magnetic field signals in the plurality of casings in a radial direction, a tangential direction, and an axial direction with respect to the plurality of casings, each of the respective one or more primary time-varying magnetic field signals inducing a corresponding one or more secondary time-varying magnetic field signals in the plurality of casings in the radial direction, the tangential direction, and the axial direction, and the one or more secondary time-varying magnetic field signals being detected by one or more of the plurality of triaxial receivers;
obtaining, using the EM inspection tool, induction measurements of the plurality of casings; and
determining, for at least one casing of the plurality of casings, a quadrant of the least one casing in which at least one defect of the at least one casing is located, based on the induction measurements.
